(19) United States
(12) Patent Application Publication
(10) Pub. No.: US 2026/0299167 A1
(43) Pub. Date: Oct. 1, 2026

(54) OPTICAL ELEMENT, METHOD FOR MANUFACTURING OPTICAL ELEMENT, MATERIAL SET, OPTICAL DEVICE, AND SYSTEM

(71) Applicant: SONY GROUP CORPORATION, Tokyo (JP)

(72) Inventors: Masanori IWASAKI, Tokyo (JP); Tsuyoshi KANEKO, Kanagawa (JP); Yui ISHII, Kanagawa (JP); Yuri Nakamura, Kanagawa (JP); Shoichi OZAWA, Kanagawa (JP)

(21) Appl. No.: 19/478,286

(22) PCT Filed: Apr. 26, 2024
(86) PCT No.: PCT/JP2024/016453

§ 371 Date: Oct. 24, 2025

(30) Foreign Application Priority Data
May 1, 2023 (JP) 2023-075453

(51) Int. Cl. G02B 1/04; B29D 11/00; G02B 1/14; G02B 5/32

(52) U.S. Cl. CPC G02B 1/043; B29D 11/00048; G02B 1/14; G02B 5/32

(57) ABSTRACT

A main object of the present technology is to provide a technology capable of suitably forming a photosensitive layer and a protective layer in relation to an optical element and a method for manufacturing the optical element. As a result of intensive studies, the present inventors have found that it is possible to form a photosensitive layer by using a photosensitive layer-forming solution prepared by dissolving a photosensitizing substance and a photosensitizing polymerizable monomer in a polar solvent, and to form a protective layer adjacent to the photosensitive layer by using a protective layer-forming solution, in which a protective polymer soluble in a protective layer solvent that does not dissolve the photosensitive layer is dissolved in the protective layer solvent, thereby suitably forming the photosensitive layer and the protective layer.

### TECHNICAL FIELD

The present technology relates to an optical element, a method for manufacturing an optical element, a material set, an optical device, and a system in which an optical device and an external device are combined. More specifically, the present technology relates to an optical element formed in such a manner that a photosensitive layer containing a photosensitizing substance and a photosensitizing polymerizable monomer and a protective layer containing no photosensitizing polymerizable monomer are formed adjacent to each other, a method for manufacturing the optical element, a material set, an optical device, and a system in which the optical device and an external device are combined.

### BACKGROUND ART

Conventionally, a method for manufacturing an optical element by laminating layers having different chemical characteristics is known.

For example, Patent Document 1 below discloses a technology for imparting various colors with complex patterns by applying a coloring component between multiple layers in a case of manufacturing a multilayer-structured lens through multistage polymerization.

### CITATION LIST

### Patent Document

Patent Document 1: Japanese Patent Application Laid-Open No. 2014-134709

### SUMMARY OF THE INVENTION

### Problems to be Solved by the Invention

A main object of the present technology is to provide a technology capable of suitably forming a photosensitive layer and a protective layer adjacent to the photosensitive layer in relation to an optical element and a method for manufacturing the optical element.

### Solutions to Problems

As a result of intensive studies, the present inventors have found that it is possible to form a photosensitive layer by using a photosensitive layer-forming solution prepared by dissolving a photosensitizing substance and a photosensitizing polymerizable monomer in a polar solvent, and to form a protective layer adjacent to the photosensitive layer by using a protective layer-forming solution, in which a protective polymer soluble in a protective layer solvent that does not dissolve the photosensitive layer is dissolved in the protective layer solvent, with the photosensitive layer and the protective layer being suitably formed in an adjacent state.

That is, in the present technology, provided is an optical element including: a base material layer; and at least a photosensitive layer and a protective layer adjacent to the photosensitive layer on one surface of the base material layer, in which the photosensitive layer contains a derivative of a photosensitizing substance and a polymer of a photosensitizing polymerizable monomer, the protective layer contains a protective polymer soluble in a protective layer solvent that does not dissolve the photosensitive layer, and a compound related to the protective layer solvent.

In the present technology, provided is an optical element including: a photosensitive layer; and a protective layer adjacent to at least one surface of the photosensitive layer, in which the photosensitive layer contains a photosensitizing substance or a derivative of the photosensitizing substance and a polymer of a photosensitizing polymerizable monomer, and the protective layer contains a protective polymer soluble in a protective layer solvent that does not dissolve the photosensitive layer, and a compound related to the protective layer solvent.

An optical element including:
a photosensitive layer; and a protective layer adjacent to at least one surface of the photosensitive layer,
in which the photosensitive layer contains a photosensitizing substance or a derivative of the photosensitizing substance and a polymer of a photosensitizing polymerizable monomer, and
the protective layer contains a protective polymer soluble in a protective layer solvent that does not dissolve the photosensitive layer, and a compound related to the protective layer solvent.

In the optical element according to the present technology, the compound related to the protective layer solvent may be contained in an amount of 0.01% by mass or more and 99% by mass or less, and the compound may include one or more compounds selected from water, a water-soluble solvent, and a non-polar solvent.

In the optical element according to the present technology, the protective polymer may include one or more compounds selected from polyvinyl alcohol, polyethylene glycol (PEG), polyethylene oxide (PEO), polyacrylamide (PAM), a carboxymethyl cellulose (CMC) resol-type phenolic resin, a methylolated urea resin, a methylolated melamine resin, and polyethylene.

In the optical element according to the present technology, a surface of the photosensitive layer opposite to the surface adjacent to the protective layer may be further adjacent to a second protective layer.

The optical element according to the present technology may further include an outer shell layer that covers at least a part of a surface of the optical element, and the outer shell layer may contain an inorganic material.

The optical element according to the present technology may not have a planar shape but may have a substantially curved surface shape, and the substantially curved surface shape may have a curvature radius of 740 mm or less or 10 mm or less.

In the optical element according to the present technology, a difference between a maximum value and a minimum value of a thickness of the photosensitive layer in a normal direction may be 10 μm or less.

In the optical element according to the present technology, the photosensitive layer can record interference fringes.

Moreover, in the present technology, provided is an optical element including: a base material layer; and at least a photosensitive layer and a protective layer adjacent to the photosensitive layer on one surface of the base material layer, in which the photosensitive layer contains a photosensitizing substance and a photosensitizing polymerizable monomer, the protective layer contains a protective polymer soluble in a protective layer solvent that does not dissolve the photosensitive layer and a compound related to the protective layer solvent.

Next, the present technology provides a method for manufacturing an optical element including: on one surface of a base material layer, forming a photosensitive layer with a photosensitive layer-forming solution prepared by dissolving at least a photosensitizing substance and a photosensitizing polymerizable monomer in a polar solvent, and forming a protective layer adjacent to the photosensitive layer with a protective layer-forming solution, in which a protective polymer soluble in a protective layer solvent that does not dissolve at least the photosensitive layer is dissolved in the protective layer solvent.

In the method for manufacturing an optical element according to the present technology, the photosensitive layer may be formed after a second protective layer is formed on the one surface of the base material layer.

In the method for manufacturing an optical element according to the present technology, the base material layer may not have a planar shape.

The method for manufacturing an optical element according to the present technology may further include: a first forming step of forming a first of the photosensitive layers and forming a first of the protective layers in a first formation region that is a part of the one surface of the base material layer; a first exposing step of exposing the first formation region; a second forming step of forming a second of the photosensitive layers and forming a second of the protective layers in a second formation region disposed in a vicinity of the first formation region on the one surface of the base material layer; and a second exposing step of exposing the second formation region.

In the method for manufacturing an optical element according to the present technology, the second formation region may be adjacent to the first formation region.

In the method for manufacturing an optical element according to the present technology, the formation may be performed by any one of methods as follows: jetting, spraying, dipping, and spin coating.

Next, the present technology provides a material set of a protective layer-forming solution that forms a protective layer adjacent to a photosensitive layer of an optical element, the material set including: a protective layer solvent that does not dissolve at least the photosensitive layer; and a protective polymer soluble in the protective layer solvent, in which the photosensitive layer is formed with a photosensitive layer-forming solution prepared by dissolving at least a photosensitizing substance and a photosensitizing polymerizable monomer in a polar solvent.

Moreover, the present technology provides an optical device including the optical element according to the present technology.

Moreover, the present technology provides a system including an optical device including the optical element according to the present technology and an external device.

### BRIEF DESCRIPTION OF DRAWINGS

FIG. 1 illustrates an example of an optical element according to a first embodiment and a method for manufacturing the optical element.

FIG. 2 illustrates an example of an optical element according to a second embodiment and a method for manufacturing the optical element.

FIG. 3 illustrates an example of an optical element according to a third embodiment and a method for manufacturing the optical element.

FIG. 4 illustrates an example of the optical element according to the third embodiment from which a base material layer has been removed by peeling.

FIG. 5 illustrates a modification of an optical element according to a fourth embodiment.

FIG. 6 illustrates a modification of the optical element and the method for manufacturing the optical element according to the first embodiment.

FIG. 7 illustrates an example in which each of the optical elements according to the first to fifth embodiments includes an outer shell layer covering at least a part of a surface of each optical element.

FIG. 8 illustrates a modification of the example in which each of the optical elements according to the first to fifth embodiments includes an outer shell layer covering at least a part of a surface of each optical element.

FIG. 9 illustrates an optical element manufactured by bonding two optical elements selected from optical elements, each being obtained by removing the base material layer illustrated in the fourth or o fifth embodiment by peeling.

FIG. 10 illustrates an optical element manufactured by bonding two optical elements selected from optical elements illustrated in the first to third embodiments or a sixth embodiment.

FIG. 11 illustrates an optical element manufactured by bonding an optical element selected from optical elements, each being obtained by removing the base material layer by peeling as illustrated in the fourth or fifth embodiment, and an optical element selected from optical elements as illustrated in the first to third embodiments or the sixth embodiment.

FIG. 12 illustrates an example of an optical element according to the ninth embodiment including two optical elements with an adhesive layer provided on adhesive surfaces of the two optical elements.

FIG. 13 illustrates a film formation process in a method for manufacturing a contact lens including an optical element according to the present technology.

FIG. 14 illustrates a lamination process in the method for manufacturing a contact lens including an optical element according to the present technology.

FIG. 15 illustrates a modification of the film formation process in the method for manufacturing a contact lens including an optical element according to the present technology.

FIG. 16 illustrates a modification of the lamination process in the method for manufacturing a contact lens including an optical element according to the present technology.

FIG. 17 illustrates a modification of the film formation process in the method for manufacturing a contact lens including an optical element according to the present technology.

FIG. 18 illustrates a modification of the lamination process in the method for manufacturing a contact lens including an optical element according to the present technology.

FIG. 19 illustrates an image of a cross-sectional structure of an example of a contact lens including an optical element according to the present technology.

FIG. 20 illustrates an image of a cross-sectional structure of a modification of a contact lens including an optical element according to the present technology.

FIG. 21 illustrates an example of a display system including a contact lens including an optical element according to the present technology and a projection system.

FIG. 22 illustrates a modification of the method for manufacturing an optical element according to the present technology.

FIG. 23 illustrates a method for manufacturing an optical element according to the related art, the optical element including a photosensitive layer that records different interference fringes in at least two regions of an optical element surface.

FIG. 24 illustrates an image of a cross-sectional structure of a modification of an optical element according to the present technology.

FIG. 25 illustrates an image of a cross-sectional structure of a modification of an optical element according to the present technology.

FIG. 26A illustrates an image of a cross-sectional structure of a modification of an optical element according to the present technology.

FIG. 26B illustrates a top view image of an example in a case where an optical element according to the present technology is used as a contact lens.

FIG. 27 illustrates an image of a cross-sectional structure of a modification of an optical element according to the present technology.

FIG. 28 illustrates an image of a cross-sectional structure of a modification of an optical element according to the present technology.

FIG. 29 illustrates a cross-sectional structure of a modification of an optical element according to the present technology and a top view image in a case where the optical element is used as a contact lens.

FIG. 30 illustrates a cross-sectional structure of a modification of an optical element according to the present technology and a top view image in a case where the optical element is used as a contact lens.

FIG. 31A illustrates an image of a cross-sectional structure of a modification of an optical element according to the present technology.

FIG. 31B illustrates an image of a cross-sectional structure of a modification of an optical element according to the present technology.

FIG. 32 illustrates an image of a cross-sectional structure of a modification of an optical element according to the present technology.

FIG. 33 illustrates an image of a cross-sectional structure of a modification of an optical element according to the present technology.

FIG. 34 illustrates an image of a cross-sectional structure of a modification of an optical element according to the present technology.

### MODE FOR CARRYING OUT THE INVENTION

Preferred embodiments of the present technology will be described later. However, the following embodiments illustrate examples of representative embodiments of the present technology, and the present technology is not limited to only the following preferred embodiments, and can be freely changed within the scope of the present technology.

### Optical Element

An optical element according to the present technology is suitably manufactured by forming, on one surface of a base material layer, at least a photosensitive layer with a photosensitive layer-forming solution prepared by dissolving a photosensitizing substance and a photosensitizing polymerizable monomer in a polar solvent, and forming at least a protective layer adjacent to the photosensitive layer with a protective layer-forming solution, in which a protective polymer soluble in a protective layer solvent that does not dissolve at least the photosensitive layer is dissolved in the protective layer solvent.

That is, the optical element according to the present technology includes at least a photosensitive layer and a protective layer adjacent to the photosensitive layer before exposure, in which the photosensitive layer contains a photosensitizing substance and a photosensitizing polymerizable monomer, the protective layer contains a protective polymer soluble in a protective layer solvent and a compound related to the protective layer solvent, and the protective layer solvent does not dissolve the photosensitive layer.

The optical element according to the present technology records the interference fringes on the photosensitive layer by exposing the optical element before the above-described exposure. As a result, it is possible to form the optical element including a base material layer and at least a photosensitive layer and a protective layer adjacent to the photosensitive layer on one surface of the base material layer, in which the photosensitive layer contains a derivative of a photosensitizing substance and a polymer of a photosensitizing polymerizable monomer, the protective layer contains a protective polymer soluble in a protective layer solvent and a compound related to the protective layer solvent, and the protective layer solvent does not dissolve the photosensitive layer.

Here, in the present specification, the “optical element” refers to an element or a combination of the elements, constituting an optical system such as focusing, diverging, reflection, refraction, diffraction and the like of light. “Elution” refers to a phenomenon in which a component is released, and includes, for example, that a component contained in one layer moves to another adjacent layer having different characteristics. The term “dissolution” refers to a phenomenon in which a substance is dissolved in a liquid to form a uniform liquid.

### Protective Layer-forming Solution

The protective layer-forming solution used for manufacturing the optical element according to the present technology is a solution in which at least a protective polymer soluble in a protective layer solvent that does not dissolve a photosensitive layer is dissolved in the protective layer solvent. Since the protective layer-forming solution does not dissolve the photosensitive layer adjacent to the protective layer, there is no possibility that components contained in the photosensitive layer such as the photosensitizing polymerizable monomer are eluted into the protective layer even though a protective layer is further formed on the photosensitive layer that has been formed. In a case where the component contained in the photosensitive layer is eluted into the protective layer, a portion with an ambiguous interface between the photosensitive layer and the protective layer occurs, and there is a possibility that optical functions of the photosensitive layer included in the optical element are affected. In the present technology, since the protective layer-forming solution does not dissolve the photosensitive layer adjacent to the protective layer, the photosensitive layer included in the optical element manufactured by the present technology is protected by the protective layer. As a result, the optical functions of the photosensitive layer can be maintained, enabling suitable recording variations in intensity of light occurring by interference fringes and the like.

In the present technology, the phrase “does not dissolve the photosensitive layer” means that the components contained in the photosensitive layer are not eluted into the protective layer solvent, and the shape of the photosensitive layer is not substantially changed. Specifically, it means that when the photosensitive layer or the protective layer is formed during the formation of the layers, a component contained in the photosensitive layer is not eluted into the protective layer solvent. Examples of the component contained in the photosensitive layer include at least a photosensitizing substance and a photosensitizing polymerizable monomer, and a plasticizer, a polymerization initiator, a binder resin, and the like also fall within the scope of inclusion in a case where such components are contained. “Not eluted” is not limited to a case where elution does not occur at all, and also includes a case where a trace component is eluted to such an extent that no functional issue occurs in performance (recording of interference fringes) of the optical element as a photosensitive layer. In the present technology, as means for “forming a layer”, film formation by coating is preferable.

In the present technology, “adjacent” means that components are adjacent to each other. In the present technology, “the photosensitive layer and the protective layer are adjacent to each other” means that the photosensitive layer and the protective layer are in contact with each other at least partially without interposing another layer therebetween. Note that, since the formed regions of the photosensitive layer and the protective layer do not coincide with each other, there are regions in which a portion of the photosensitive layer and a portion of the protective layer are adjacent but not in contact with each other.

In the method for manufacturing an optical element according to the present technology, the order of formation of the photosensitive layer and the protective layer is not limited, and the protective layer may be formed with the protective layer-forming solution on the photosensitive layer formed with the photosensitive layer-forming solution, or the photosensitive layer may be formed with the photosensitive layer-forming solution on the protective layer formed with the protective layer-forming solution.

The protective layer included in the optical element according to the present technology inhibits a chemical reaction caused by oxidation or the like of a component of the photosensitive layer. As the material such as the protective polymer that forms the protective layer, it is preferable to use a material that is soluble in the protective layer solvent that does not dissolve the photosensitive layer, and has high light transmittance and low oxygen permeability from the viewpoint of recording, by the photosensitive layer, variations in intensity of light occurring due to interference fringes or the like. Here, as the material having a low oxygen permeability, a material having an oxygen transmission rate, measured in an environment of, for example, 23° C. and 0% RH, more than 0. 1 cm3/(m²·day·atm) and 10000 cm³/(m²—day—atm) or less is considered. As an example of such materials, for example, polyvinyl alcohol (PVA), polyethylene glycol (PEG), polyacrylamide (PAM), carboxymethyl cellulose (CMC), a resol-type phenolic resin, a methylolated urea resin, a methylolated melamine resin, a cycloolefin-based resin such as a cycloolefin polymer (COP), polyethylene, and the like can be suitably used. The substrate layer may be a layer including a single compound or may be a layer including a composition containing a plurality of compounds. Note that the above-described polyethylene glycol encompasses the concept of polyethylene oxide (PEO).

In the optical element according to the present technology, as the thickness of the protective layer, a thickness capable of achieving high light transmittance and low oxygen permeability can be appropriately selected according to the application of the optical element. For example, the thickness of the protective layer can be within any range of 0.01 μm or more, 0.1 μm or more, 1 μm or more, and the like. Furthermore, the upper limit of the thickness of the protective layer is not particularly limited, and can be adjusted within any range of, for example, 50 μm or less, 20 μm or less, 10 μm or less, and the like.

In particular, in the present technology, since the protective layer-forming solution can be applied with any thickness, the occurrence of thickness unevenness of the protective layer can be suitably avoided.

### Protective Layer Solvent

The protective layer solvent used in the protective layer-forming solution is not particularly limited as long as it is a solvent that does not dissolve the photosensitive layer. The solvent that does not dissolve the photosensitive layer is, for example, one or more solvents selected from water, a water-soluble solvent, and a non-polar solvent in a case where the photosensitive layer uses a polar solvent. The use of the protective layer-forming solution adjusted using the solvent can suitably inhibit elution of the photosensitive layer into the protective layer even though a protective layer is further formed on the photosensitive layer that has been formed.

Examples of the non-polar solvent used in the protective layer-forming solution include one or more compounds selected from hexane, xylene, and the like, and examples of the water-soluble solvent used in the protective layer-forming solution include one or more compounds selected from ethyl acetate and the like, or include water. These compounds may be used alone or as a mixture containing a plurality of compounds.

A method for forming the layers used for manufacturing of the optical element according to the present technology is not particularly limited, and a known method can be suitably used. Formation refers to, for example, film formation or lamination, and a specific method includes, for example, coating. Examples of a coating method include methods such as jetting, spraying, dipping, and spin coating, and a layer can be suitably formed by these methods. Known methods can be suitably employed as these coating methods, and, as examples of jetting, known spraying processes such as air atomization and delivery processes, ultrasonic atomization and delivery processes, piezoelectric atomization and delivery processes, electromechanical jet printing processes, piezoelectric jet printing processes, hydrostatic piezoelectric jet printing processes, and thermal jet printing processes can be suitably used.

On the basis of the method for manufacturing an optical element according to the present technology, the formed protective layer contains a protective polymer soluble in the protective layer solvent that does not dissolve the photosensitive layer, and a compound related to the protective layer solvent.

The compound related to the protective layer solvent in the protective layer is partially or entirely volatilized through an exposing step and a heating step as described later. In a case where a part of the compound related to the protective layer solvent remains in the protective layer of. the optical element according to the present technology, the remaining compound may be contained within a range of, for example, 0.01% by mass or more, 0.1% by mass or more, or the like with respect to 100 mass of the composition for forming the protective layer. Furthermore, the upper limit of the content of the compound related to the protective layer solvent in the protective layer is not particularly limited, and the compound may be contained within a range of, for example, 99% by mass or less, 70% by mass or less, or 1.0% by mass or less. Note that the above-described range is defined on the basis of the measurable value of the compound related to the protective layer solvent in the protective layer at the time of filing of the present technology. However, in the present technology, the compound related to the protective layer solvent in the protective layer does not ensure the function of the protective layer, and the compound may entirely volatilize in the process of manufacturing the optical element according to the present technology. Therefore, the present technology is not limited to the above-described range.

For the optical element according to the present technology, the photosensitive layer and the protective layer can be suitably formed by applying a solution such as the photosensitive layer-forming solution to one surface of the base material layer. Therefore, even in a case where the optical element is used for the manufacturing an optical element that does not have a planar shape in which it is difficult to suppress the occurrence of wrinkles in a film bonding method using a film including a photosensitive layer, wrinkles do not occur, and the occurrence of thickness unevenness can be suppressed. Furthermore, since bonding of the films is not performed by stretching the films or by applying heat to shrink the films, a temporal change in shape due to residual stress after the bonding does not occur.

Here, the “planar shape” refers to a surface on which a straight line passing through any two points is always present, and in the present technology, the photosensitive layer and the protective layer can be suitably formed even on a surface that is included in the base material layer or the like and that does not satisfy such conditions. For surfaces that are not planar, it is conceivable that, among two straight lines intersecting at any angle and passing through any two points, one of the lines is not on the same plane, or both lines are not on the same plane. Examples of cases in which one straight line of the straight lines passing through any two points is not on the same surface include cylindrical shapes, substantially cylindrical shapes, wavy structures (wavy pattern structures), and substantially wavy structures. Examples of a case where both straight lines of the straight lines passing through any two points are not on the same surface include a curved surface shape, a substantially curved surface shape, and the like. Here, the term “substantially” refers to a state that is not entirely or completely but is close thereto, and for example, the term “substantially curved surface shape” refers to a shape that is not a completely curved surface shape but is close thereto, such as including a planar shape or a surface that is not a planar shape in a part.

Therefore, according to the present technology, even in an optical element having a curved surface shape or a substantially curved surface shape in at least a part thereof, the photosensitive layer and the protective layer can be suitably formed according to the present technology. Here, in the present specification, the “substantially curved surface shape” includes a shape in which the curvature radius of the peripheral portion and the curvature radius in the vicinity of the center have different shapes from each other as illustrated in FIGS. 14F, 16F, and 18D as described later.

In the optical element according to the present technology, the protective layer is formed as a layer adjacent to the photosensitive layer for the purpose of protecting components of the photosensitive layer from oxidation and the like. Therefore, it is preferable that the surface of the photosensitive layer is formed so as not to be exposed to the outside. Here, since it is sufficient that the surface of the photosensitive layer can be formed so as not to be exposed to the outside, it is also possible to form a photosensitive layer with the photosensitive layer-forming solution on the protective layer (“second protective layer”) formed with the protective layer-forming solution (“second protective layer-forming solution”), and then further form the protective layer (“first protective layer”) with the protective layer-forming solution (“first protective layer-forming solution”).

Here, the above-described first protective layer-forming solution and second protective layer-forming solution may be the same as or different from each other. Note that since all of the protective layer-forming solutions use the protective layer solvent that does not dissolve the photosensitive layer, elution of the photosensitive layer into the first protective layer or the second protective layer can be suppressed.

In view of the above-described characteristics, according to the present technology, it is possible to suitably form a photosensitive layer capable of suitably recording interference fringes and the like also on the surface of an optical element included in an optical device having, at least in part, a curved surface shape such as an optical lens used for contact lenses, eyeglass lenses, camera lenses, or the like, or a display device having any shape according to a purpose.

The curved surface shape in which a layer can be formed using the present technology is not particularly limited, and can correspond to any shape according to the application of the optical element. For example, in a case where the shape of a human eyeball is assumed as a contact lens, for example, the curvature radius is 10 mm or less or the like. Furthermore, since the shape of the eyeball of not only a human but also any animal can be handled, a curvature radius of, for example, 50 mm or less, 40 mm or less, 30 mm or less, 20 mm or less, or the like can be appropriately selected according to the shape of the eyeball of the target animal. Furthermore, in a case where the eyeglass lenses are assumed, for example, any curvature radius can be appropriately selected according to the shape of the target eyeglass lens, such as a curvature radius of 740 mm or less, 130 mm or less, or 65 mm or less.

The protective layer-forming solution according to the present technology may contain other components in addition to those described above, as necessary, as long as desired various physical properties are not significantly impaired. One kind of these may be contained, or two or more kinds thereof may be contained in any combinations and ratios.

### Photosensitive Layer-Forming Solution

The photosensitive layer-forming solution used for manufacturing the optical element according to the present technology is a solution obtained by dissolving at least a photosensitizing substance and a photosensitizing polymerizable monomer in a polar solvent. The photosensitive layer can be suitably formed by forming the photosensitive layer-forming solution on one surface or the like of the base material layer.

Here, the “photosensitive layer” is a layer in which a compound contained in the layer reacts upon receiving light to cause a chemical change, and is a layer that suitably records interference fringes and the like generated by interference light. Since the photosensitive layer before exposure according to the present technology contains the photosensitizing substance and the photosensitizing polymerizable monomer, a photochemical reaction proceeds by light energy transmitted from the photosensitizing substance to the photosensitizing polymerizable monomer by light irradiation such as exposure, resulting in synthesis of a polymer of the photosensitizing polymerizable monomer. Here, the “photochemical reaction” refers to a chemical reaction caused by a substance that has absorbed light.

### Photosensitizing Substance

The photosensitizing substance contained in the photosensitive layer-forming solution used for manufacturing the optical element according to the present technology includes a substance capable of causing “photosensitization”, and specifically refers to a substance that absorbs energy of light having a specific wavelength and transmits the energy to a reactant such as a polymerization initiator or a photosensitizing polymerizable monomer to cause a photochemical reaction such as a polymerization reaction of the reactant.

In the present technology, the photosensitizing substance contained in the formed photosensitive layer can be a derivative of the photosensitizing substance obtained through the exposing step and the heating step as described later. Here, the “derivative” refers to a compound produced by a chemical change in a part of the molecule of a certain compound, and in the present technology, a compound produced by a bond between a certain compound and another compound is also included. That is, in the present technology, the “photosensitizing substance derivative” refers to a compound produced by a change in a part of the molecule of the photosensitizing substance, and also includes a compound produced by binding the photosensitizing substance to another compound.

The photosensitizing substance described above may contain at least one ionic sensitizing dye. In a case where the photosensitive layer according to the present technology before exposure contains an ionic sensitizing dye, the effect of improving the light absorption efficiency of the photosensitive layer by using the polyhydric alcohol is particularly remarkable. The photosensitizing substance may contain either or both of a dye that absorbs light in a visible light region or a near-infrared light region and a UV sensitizing dye (such as an anthracene compound) added for the purpose of improving light efficiency during UV irradiation.

Furthermore, only one kind of the photosensitizing substance may be used, or a plurality of kinds of photosensitizing substances may be used to respond to a plurality of wavelengths. The photosensitizing substance may contain at least two kinds of sensitizing dyes having absorption in a visible light region or a near-infrared light region. In this case, these at least two kinds of photosensitizing substances may contain at least one ionic photosensitizing substance. The photosensitizing substance exhibiting absorption in the visible light region or the near-infrared light region may have the maximum value of the absorption spectrum of the photosensitizing substance that lies within the visible light region or the near-infrared light region. In the present specification, the visible light region or near-infrared light region refers to a wavelength range of 360 nm or more and 970 nm or less.

Examples of the photosensitizing substance include thiopyrylium salt-based dyes, merocyanine-based dyes, quinoline-based dyes, styrylquinoline-based dyes, ketocoumarin-based dyes, thioxanthene-based dyes, xanthene-based dyes, oxonol-based dyes, cyanine-based dyes, rhodamine-based dyes, and pyrylium salt-based dyes.

The content of the photosensitizing substance contained in the photosensitive layer-forming solution used in the manufacturing the optical element according to the present technology is not particularly limited, and can be suitably adjusted within a range in which a photochemical reaction such as a polymerization reaction of a reactant such as a photosensitizing polymerizable monomer can be suitably caused.

### Photosensitizing Substance

### Photosensitizing Polymerizable Monomer

The photosensitizing polymerizable monomer contained in the photosensitive layer-forming solution used for manufacturing the optical element according to the present technology is a monomer that is a low molecular weight compound, and is a compound capable of undergoing polymerization as a photochemical reaction, initiated by light energy transmitted from a photosensitizing substance, to produce a polymer.

In a case where exposure is performed on the photosensitive layer according to the present technology by providing light and darkness within the irradiation range with a method such as irradiation with interference light, a photochemical reaction proceeds in a region receiving a large amount of light irradiation due to the light energy transmitted from the photosensitizing substance, and a polymer of the photopolymerizable monomer is synthesized. On the other hand, the polymerization reaction does not proceed in a region where the amount of light irradiation is relatively smaller than that in the region.

Therefore, a concentration gradient of the polymer of the photosensitizing polymerizable monomer occurs on the basis of the difference in the progress of the polymerization reaction described above, and a phase separation structure is formed in the composition according to the present technology.

By utilizing the above-described characteristics, the photosensitive layer according to the present technology can record interference fringes. Therefore, the optical element according to the present technology can control an light beam by diffracting the incident light beam with the interference fringes recorded as a hologram, for example.

There are no particular limitations on the photosensitizing polymerizable monomer contained in the photosensitive layer-forming solution used for manufacturing the optical element according to the present technology, as long as it is a compound capable of producing a polymer by a polymerization reaction as a photochemical reaction, initiated by light energy transmitted from a photosensitizing substance. For example, the photosensitizing polymerizable monomer include a radically polymerizable compound, a cationically polymerizable compound, or both. The photosensitizing polymerizable monomer may include an anionically polymerizable compound. The photosensitizing polymerizable monomer may include a polymerizable monomer, a polymerizable oligomer, or a mixture thereof. The photosensitizing polymerizable monomer may include a monofunctional compound, a polyfunctional compound, or a mixture thereof. The photosensitizing polymerizable monomer may include one kind of polymerizable compound or two or more kinds of polymerizable compounds.

As the photosensitizing polymerizable monomer contained in the photosensitive layer-forming solution used for manufacturing the optical element according to the present technology, for example, a monomer of an unsaturated carboxylic acid or the like can be used. Specific examples of the monomer of the unsaturated carboxylic acid include acrylic acid, methacrylic acid, itaconic acid, crotonic acid, isocrotonic acid, maleic acid, and halogen-substituted unsaturated carboxylic acids thereof, such as chlorinated unsaturated carboxylic acids, brominated unsaturated carboxylic acids, and fluorinated unsaturated carboxylic acids. Examples of the salt of the unsaturated carboxylic acid include sodium salts and potassium salts of the above-described acids. Here, the photosensitizing polymerizable monomer used in the present technology preferably has at least one ethylenically unsaturated double bond in the molecule.

Examples of the photosensitizing polymerizable monomer used in the present technology include methyl methacrylate, hydroxyethyl methacrylate, lauryl acrylate, N-acryloylmorpholine, 2-ethylhexyl carbitol acrylate, isobornyl acrylate, methoxypropylene glycol acrylate, 1,6-hexanediol diacrylate, tetraethylene glycol diacrylate, trimethylolpropane triacrylate, pentaerythritol triacrylate, pentaerythritol tetraacrylate, acrylamide, methacrylamide, styrene, 2-bromostyrene, phenyl acrylate, 2-phenoxyethyl acrylate, 2,3-naphthalenedicarboxylic acid (acryloxyethyl) monoester, methylphenoxyethyl acrylate, nonylphenoxyethyl acrylate, β-acryloxyethyl hydrogen phthalate, phenoxypolyethylene glycol acrylate, 2,4,6-tribromophenyl acrylate, diphenic acid (2-methacryloxyethyl) monoester, benzyl acrylate, 2,3-dibromopropyl acrylate, 2-hydroxy-3-phenoxypropyl acrylate, 2-naphthyl acrylate, N-vinylcarbazole, 2-(9-carbazolyl)ethyl acrylate, triphenylmethylthioacrylate, 2-(tricyclo[5.2.1.02·6]dibromodecylthio) ethyl acrylate, S-(1-naphthylmethyl) thioacrylate, dicyclopentanyl acrylate, methylenebisacrylamide, polyethylene glycol diacrylate, trimethylolpropane triacrylate, pentaerythritol triacrylate, diphenic acid (2-acryloxyethyl) (3-acryloxypropyl-2-hydroxy) diester, 2,3-naphthalenedicarboxylic acid (2-acryloxyethyl) (3-acryloxypropyl-2-hydroxy) diester, 4,5-phenanthrenedicarboxylic acid (2-acryloxyethyl) (3-acryloxypropyl-2-hydroxy) diester, dibromoneopentyl glycol diacrylate, dipentaerythritol hexaacrylate, 1,3-bis[2-acryloxy-3-(2,4,6-tribromophenoxy)propoxy]benzene, diethylenedithioglycol diacrylate, 2,2-bis(4-acryloxyethoxyphenyl) propane, bis(4-acryloxy-diethoxyphenyl)methane, bis(4-acryloxyethoxy-3,5-dibromophenyl)methane, 2,2-bis(4-acryloxyethoxyphenyl)propane, 2,2-bis(4-acryloxy-diethoxyphenyl)propane, 2,2-bis(4-acryloxyethoxy-3,5-dibromophenyl)propane, bis(4-acryloxyethoxyphenyl)sulfone, bis(4-acryloxy-diethoxyphenyl)sulfone, bis(4-acryloxypropoxyphenyl)sulfone, and bis(4-acryloxyethoxy-3,5-dibromophenyl)sulfone, as well as compounds obtained by replacing the acrylate group in the above with a methacrylate group, for example; furthermore, compounds containing at least two sulfur atoms within the molecule, such as ethylenically unsaturated compounds such as those described in Japanese Patent Application Laid-Open No. H02-247205 and Japanese Patent Application Laid-Open No. H02-261808, and these may be used alone or in combination of two or more kinds.

The photosensitizing polymerizable monomer capable of being contained in the photosensitive layer of the optical element according to the present technology may contain a polymerizable compound other than the aforementioned monomer, either in place of the monomer of the unsaturated carboxylic acid or together with the monomer of the unsaturated carboxylic acid.

The content of the photosensitizing polymerizable monomer contained in the photosensitive layer-forming solution used for manufacturing the optical element according to the present technology is not particularly limited, and can be suitably adjusted within a range in which a polymerization reaction occurs as a photochemical reaction, initiated by light energy transmitted from the photosensitizing substance, and interference fringes can be suitably recorded.

### Polar Solvent

The polar solvent that is a solvent of the photosensitive layer-forming solution used for manufacturing the optical element according to the present technology is not particularly limited as long as it is a solvent that dissolves the photosensitizing polymerizable monomer. The solvent contains, for example, one or more compounds selected from the group including methyl ethyl ketone (MEK), toluene, xylene, ethanol (EtOH), propylene glycol, acetone, tetrahydrofuran, benzene, methylene chloride, dichloromethane, chloroform, methanol, and the like. These compounds may be used alone or as a mixture containing a plurality of compounds. In particular, methyl ethyl ketone, toluene, and xylene are non-polar solvents when used alone; however, by mixing with a polar solvent such as ethanol, these solvents can function as polar solvents capable of dissolving photosensitizing polymerizable monomers. In the present technology, the viscosity and film formability of the photosensitive layer-forming solution can be suitably improved by selecting a solvent.

The photosensitive layer formed on the basis of the method for manufacturing an optical element according to the present technology contains a photosensitizing substance and a photosensitizing polymerizable monomer before undergoing the exposing step and the heating step as described later. Thereafter, the photochemical reaction proceeds by the exposing step, and the photosensitizing substance or the derivative of the photosensitizing substance and the polymer of the photosensitizing polymerizable monomer are contained.

Furthermore, in the photosensitive layer described above, a compound related to a polar solvent that is a solvent of the photosensitive layer-forming solution is partially or entirely volatilized during curing at the time of forming the photosensitive layer or through the exposing step and the heating step. Note that in a case where a part of the compound related to the polar solvent remains in the photosensitive layer of the optical element according to the present technology, the remaining compound may be contained within a range of, for example, 0.01% by mass or more, 0.1% by mass or more, and the like with respect to 100 mass of the composition for forming the photosensitive layer. Furthermore, the upper limit of the content of the compound is not particularly limited, and the compound may be contained within a range of, for example, 50% by mass or less, 10% by mass or less, 1.0% by mass or less, and the like. Note that the above-described range is defined on the basis of the measurable value of the compound related to the polar solvent in the photosensitive layer at the time of filing of the present technology. However, in the present technology, the compound related to the polar solvent in the photosensitive layer does not ensure the function of the photosensitive layer, and the compound may entirely volatilize in the process of manufacturing the optical element according to the present technology. Therefore, the present technology is not limited to the above-described range.

In the optical element according to the present technology, the thickness of the photosensitive layer is not limited to the above-described range, and the photosensitive layer can be formed to have any thickness according to the application of the optical element. In particular, since the photosensitive layer can be formed by coating, it is possible to achieve a thickness of 0.1 μm or less, which is difficult to be achieved by a molding method. The thickness of the photosensitive layer of the optical element according to the present technology can be formed in any range of, for example, 1 μm or more, 10 μm or more, 20 μm or more, or the like. Furthermore, the upper limit of the thickness of the photosensitive layer is not particularly limited, and can be adjusted within any range of, for example, 100 μm or less, 50 μm or less, 20 μm or less, or the like.

In particular, in the present technology, since the photosensitive layer-forming solution can be applied at any thickness, for example, even in an optical element having a non-planar shape, it is possible to suitably avoid the occurrence of wrinkles (partial overlaps of the film/the thickness of overlapped films) that can occur in a film-lamination method, as well as thickness unevenness that can occur due to coating methods prone to coating unevenness. Specifically, the maximum thickness of the photosensitive layer in the normal direction can be twice the minimum thickness or less, preferably the same value or less, and still more preferably half the minimum thickness or less. More specifically, the difference between the maximum value and the minimum value of the thickness of the photosensitive layer in the normal direction can be 10 μm or less, preferably 5 μm or less, and still more preferably 1 μm or less. Moreover, the maximum thickness of the surface of the optical element formed by coating or the like in the normal direction can be twice the minimum thickness or less, preferably the same value or less, and still more preferably half the minimum thickness or less. More specifically, the difference between the maximum value and the minimum value of the thickness of the surface of the optical element formed by coating or the like in the normal direction can be 20 μm or less, preferably 5 μm or less, and still more preferably 1 μm or less.

Here, the maximum value and the minimum value of the thickness in the normal direction can be determined, for example, on the basis of the thickness measured at any three or more points on the surface of the target layer or element. Examples of any points include an end portion and a central portion (a geometric center and a center of gravity) of a surface of a target layer or element.

In the present technology, the thickness can be suitably adjusted to the above-described range by a method such as jetting, spraying, or dipping.

The photosensitive layer-forming solution according to the present technology may contain the following components in addition to the above-described components.

### Plasticizer

The photosensitive layer-forming solution according to the present technology may further contain a plasticizer. The plasticizer can be effective for expressing a high amount of refractive index change (Δn). Furthermore, the plasticizer can also be effective for adjustment of the adhesion, the flexibility, the hardness, and other physical characteristics of the composition for the photosensitive layer. The plasticizer may contain at least one selected from the group including an ester-based plasticizer and an ether-based plasticizer.

In the present technology, specific examples of plasticizers include, for example, triethylene glycol, triethylene glycol diacetate, triethylene glycol dipropionate, triethylene glycol dicaprylate, triethylene glycol dimethyl ether, poly(ethylene glycol), poly(ethylene glycol)methyl ether, triethylene glycol bis(2-ethylhexanoate), tetraethylene glycol diheptanoate, dibutyl suberate, tris(2-ethylhexyl) phosphate, isozorolbyl naphthalene, diisopropylnaphthalene, poly(propylene glycol), glyceryl tributyrate, diethyl adipate, diethyl sebacate, dibutyl suberate, tributyl phosphate, and phosphoric acid tris(2-ethylhexyl).

The plasticizer may be nonionic. In a case where the plasticizer is nonionic, the light absorption efficiency of the photosensitive layer decreases in a case where the photosensitive layer contains an ionic photosensitizing substance; however, the light absorption efficiency can be improved by further including a polyhydric alcohol in the photosensitive layer.

The reason for the improvement of the light absorption efficiency described above is considered to be as follows. Since the ionic photosensitizing substance has poor dispersibility with respect to a nonionic plasticizer, the dispersibility of the ionic photosensitizing substance in the photosensitive layer is deteriorated when the photosensitive layer contains the nonionic plasticizer. By including the polyhydric alcohol in the photosensitive layer containing the nonionic plasticizer, dispersibility of the ionic photosensitizing substance in the photosensitive layer is improved, and the light absorption rate of the photosensitive layer is increased.

The plasticizer may have a polymerizable reactive group. The plasticizer having a polymerizable reactive group may be a cationic polymerizable compound (cationic polymerizable monomer). The cationic polymerizable monomer contains, for example, at least one selected from the group including an epoxy compound and an oxetane compound. Here, the epoxy compound includes an alicyclic epoxy compound. In a case where the photosensitive composition contains at least one selected from the group including an epoxy compound and an oxetane compound as the plasticizer, the effect of improving the light absorption efficiency of the photosensitive layer by the polyhydric alcohol is particularly remarkable.

### Polymerization Initiator

The photosensitive layer-forming solution according to the present technology may further contain a polymerization initiator. The “polymerization initiator” in the present technology refers to a substance necessary for easily generating radicals or ions and initiating a chain polymerization reaction. In the photosensitive layer-forming solution according to the present technology, the polymerization initiator is a compound capable of initiating a polymerization reaction of a photosensitizing polymerizable monomer or a plasticizer.

The polymerization initiator that can be contained in the photosensitive layer-forming solution according to the present technology can be appropriately selected in accordance with the characteristics of the photosensitizing polymerizable monomer and the plasticizer contained in the photosensitive layer-forming solution. The polymerization initiator may include a radical polymerization initiator (radical generator), a cationic polymerization initiator (acid generator), or those having both functions. Note that the polymerization initiator may contain an anionic polymerization initiator (base generator).

Examples of polymerization initiators used in the present technology include 1,3-di(t-butyl dioxocarbonyl)benzophenone, 3,3′,4,4′-tetrakis(t-butyl dioxocarbonyl)benzophenone, N-phenylglycine, 2,4,6-tris(trichloromethyl)-s-triazine, 3-phenyl-5-isoxazolone, 2-mercaptobenzimidazole, and imidazole dimers. Moreover, examples of a photocationic polymerization initiator (cationic polymerization initiator) include aromatic diazonium salts, aromatic iodonium salts, aromatic sulfonium salts, aromatic phosphonium salts, mixed ligand metal salts, for example, (η-benzene) (η5-cyclopentanol dyes, cyanine dyes, rhodamine dyes, and pyrylium salt dyes. These polymerization initiators may be used alone or in combination of a plurality of compounds.

In the photosensitive layer-forming solution according to the present technology, a polymerization initiator may be contained in the solution in advance, or a polymerization initiator may be added at the time of use. A suitable use form can be suitably adopted according to the use form of the photosensitive layer-forming solution according to the present technology.

Examples of the form in which the polymerization initiator is added during use include a case in which a photosensitive layer-forming solution containing components other than the polymerization initiator is mixed, at the time of use, with a solution or composition containing the polymerization initiator; however, the use of such a form is not limited thereto.

The content of the polymerization initiator that may be contained in the photosensitive layer-forming solution according to the present technology is not particularly limited; however, by including, for example, 1% by mass or more, still more preferably 3% by mass or more, and particularly preferably 5% by mass or more with respect to 100% by mass of the composition, the polymerization reaction of the polymerizable monomer or radically polymerizable organic monomer can be suitably initiated.

The upper limit of the content of the polymerization initiator that can be contained in the composition according to the present technology is not particularly limited, but can be adjusted to a range of, for example, 50% by mass or less, still more preferably 30% by mass or less, and particularly preferably 25% by mass or less with respect to 100% by mass of the composition.

### Binder Resin

The photosensitive layer-forming solution according to the present technology may further contain a binder resin. The “binder resin” contained in the photosensitive layer-forming solution according to the present technology is a polymer compound capable of suitably dispersing components contained in the photosensitive layer according to the present technology in the photosensitive layer. Furthermore, the binder resin can be effective for improving the film strength and improving the heat resistance and the mechanical strength.

Since the photosensitive layer-forming solution according to the present technology contains the binder resin, it is possible to maintain a concentration gradient generated with the progress of the polymerization reaction of the photosensitizing polymerizable monomer, so that the interference fringes can be suitably recorded by a method such as irradiating the photosensitive layer according to the present technology with interference light. Therefore, three-dimensional image information and the like can be suitably recorded, and thus, can be suitably used for applications such as holograms.

The binder resin that can be contained in the photosensitive layer-forming solution according to the present technology is not particularly limited as long as it is a polymer compound having a low glass transition point (Tg) at which the components contained in the photosensitive layer in the composition can be suitably dispersed.

Examples of binder resins that may be used in the present technology include polymethacrylic acid esters or partially hydrolyzed products thereof; polyvinyl acetate or hydrolyzed products thereof; polyvinyl alcohol or partially acetalized products thereof; triacetyl cellulose; polyisoprene; polybutadiene; polychloroprene; silicone rubber; polystyrene; polyvinyl butyral; polyvinyl chloride; chlorinated polyethylene; chlorinated polypropylene; poly-N-vinylcarbazole or derivatives thereof; poly-N-vinylpyrrolidone or derivatives thereof; copolymers of styrene and maleic anhydride or half esters thereof; and copolymers including, as polymerized units, monomers selected from copolymerizable monomers such as acrylic acid, acrylic acid esters, methacrylic acid, methacrylic acid esters, acrylamide, acrylonitrile, ethylene, propylene, vinyl chloride, and vinyl acetate. These can be used alone or in combination of two or more kinds thereof.

Regarding the polymer compound that can be used as the binder resin described above, the range of Tg can be adjusted so that the component can be suitably dispersed in accordance with the component of the composition according to the present technology.

The content of the binder resin that can be contained in the photosensitive layer-forming solution according to the present technology is not particularly limited, and by including, for example, 1% by mass or more, still more preferably 10% by mass or more, and particularly preferably 15% by mass or more relative to 100% by mass of the Composition, the components contained in the composition can be suitably dispersed within the composition.

The upper limit of the content of the binder resin that can be contained in the composition according to the present technology is not particularly limited, and can be adjusted to any range according to the components of the composition.

As a photosensitive composition for producing volume holograms, the Omnidex series from DuPont de Nemours, Inc. is commercially available at the only mass production level. This material contains a photosensitizing polymerizable monomer and a binder resin, a polymerization initiator, and a photosensitizing substance as main components, and utilizes a difference in refractive index between the photosensitizing polymerizable monomer and the binder resin. That is, when the photosensitive composition formed into a film is subjected to interference exposure, radical polymerization is initiated in regions where the light intensity is high, thereby generating a concentration gradient of the photosensitizing polymerizable monomer, and diffusion migration of the photosensitizing polymerizable monomer occurs from a low-light-intensity region to a high-light-intensity region. As a result, according to the variations in intensity of the interference light cause differences in the density of the photosensitizing polymerizable monomer, which is exhibited as differences in refractive index. Furthermore, a material system using both radical polymerization and cationic polymerization has been reported.

### Other Components

The photosensitive layer-forming solution according to the present technology may contain other components in addition to those described above, as necessary, as long as desired various physical properties are not significantly impaired. Examples of other components include a chain transfer agent and a polymerization inhibitor. One kind of these may be contained, or two or more kinds thereof may be contained in any combinations and ratios.

### Base Material Layer

In the optical element according to the present technology, the “base material layer” is a layer that supports a process of forming a photosensitive layer-forming solution or the like into a photosensitive layer or the like in the method for manufacturing an optical element according to the present technology, Specifically, the base material layer is a layer on which the photosensitive layer can be formed on one surface thereof by a method such as coating with the photosensitive layer-forming solution. That is, in the optical element according to the present technology, the photosensitive layer is formed by applying the photosensitive layer-forming solution or the like to one surface of the base material layer, and the protective layer adjacent to the photosensitive layer is formed by applying or the like with the protective layer-forming solution. Furthermore, here, only the term “base material layer” is used for convenience, and the “base material layer” may be, for example, one that can be supported and molded (molded or the like) with a photosensitive layer interposed therebetween like a mold. In such a case, a level of strength sufficient to function as a molding mold is required.

The material for forming the “base material layer” in the optical element according to the present technology is not particularly limited as long as it is a material enabling application of the above-described photosensitive layer-forming solution and the like, and a suitable material can be appropriately selected according to a product including the optical element to be manufactured. For example, in a case where a material having high optical transparency is used as the material of the base material layer, object light and reference light can be emitted to the photosensitive layer from different directions, thereby allowing the photosensitive layer to suitably record interference fringes as a hologram that controls light beams through reflection and diffraction of the incident light. Furthermore, in a case of recording interference fringes or the like as a hologram that diffracts incident light in a transmission direction to control light beams, it is sufficient that the object light and the reference light can be emitted to the photosensitive layer from the same direction. Thus, a material having low light transmittance can also be used as the material of the base material layer. Moreover, by using a material having low oxygen permeability as the base material layer, it can also function as a layer that protects the photosensitive layer.

In the method for manufacturing an optical element according to the present technology, the optical element of the present technology can be suitably produced by forming the photosensitive layer on one surface of the base material layer with the above-described photosensitive layer-forming solution, and then forming the protective layer adjacent to the photosensitive layer with the protective layer-forming solution.

The optical element according to the present technology can also be produced by implementing the above-described manufacturing method by using a solution set for manufacturing the optical element containing the photosensitive layer-forming solution prepared by dissolving at least the photosensitizing substance and the photosensitizing polymerizable monomer in the polar solvent, and the protective layer-forming solution in which at least the protective polymer soluble in the protective layer solvent that does not dissolve the photosensitive layer is dissolved in the protective layer solvent. Moreover, by using the protective layer-forming solution produced using the material set, which contains at least the protective layer solvent that does not dissolve the photosensitive layer and the protective polymer soluble in the protective layer solvent, the above-described manufacturing method can be carried out to produce the optical. element of the present technology.

Here, the base material layer and the photosensitive layer do not need to be adjacent to each other, and the other layer may be present between the base material layer and the photosensitive layer. That is, the phrase “applied to one surface of the base material layer” is not limited to a case of direct application to the base material layer, but also includes a case of application via the other layer formed on one surface of the base material layer. For example, the optical element may be manufactured by forming a second protective layer on one surface of the base material layer, and then forming the photosensitive layer, and further forming the protective layer. Moreover, for example, after a layer containing an inorganic material such as SiO₂, TiO₂, Al₂O₃, or SiNₓ is formed as an outer shell layer on one surface of the base material layer, the photosensitive layer is formed, and a protective layer is further formed, thereby manufacturing the optical element.

The optical element manufactured by the method for manufacturing an optical element according to the present technology can also be manufactured by peeling the base material layer at the interface between the base material layer and the layer adjacent thereto. The obtained optical element includes a photosensitive layer and a protective layer adjacent to at least one surface of the photosensitive layer, the photosensitive layer contains a photosensitizing substance or a derivative of the photosensitizing substance and a polymer of a photosensitizing polymerizable monomer, and the protective layer contains a protective polymer soluble in a protective layer solvent that does not dissolve the photosensitive layer, and a compound related to the protective layer solvent.

Since the optical element obtained as described above has a film shape in which the base material layer has been separated, the optical element can be processed into any shape by means such as cutting. Moreover, by transferring the processed optical element to another member, a function of a hologram can be imparted to a member having any shape. Here, the “film” refers to a molded body molded into a film shape having any thickness, and is not limited to a planar shape like a general film, and may have a substantially curved surface shape.

In the optical element described above, the layer adjacent to the base material layer is not limited, and examples thereof include the photosensitive layer and the second protective layer described above. In particular, from the viewpoint of protecting the components of the photosensitive layer from oxidation and the like, the optical element preferably includes protective layers (a first protective layer and a second protective layer) adjacent to both surfaces of the photosensitive layer.

The optical element according to the present technology may have the following layers in addition to the above-described layers.

### Outer Shell Layer

The optical element according to the present technology may further include an outer shell layer that covers at least a part of a surface of the optical element. In the present technology, the “outer shell layer” refers to a layer that covers at least a part of the surface of the optical element to inhibit leakage of the components of the photosensitive layer and the protective layer due to elution or the like.

In a case where the optical element according to the present technology has an outer shell layer, it is possible to efficiently inhibit leakage of the components of the photosensitive layer and the protective layer due to elution or the like, so that it is possible to enhance safety of a product including the optical element according to the present technology. In particular, in a case where the optical element is used in a product such as a contact lens that comes into contact with a mucous membrane or the like having high absorption into the body, it is preferable to include an outer shell layer.

Since the outer shell layer is provided on the surface in contact with the user to enhance the safety of the optical element, the outer shell layer may cover at least a part of the surface of the optical element that can be in contact with the user, but may cover the entire surface on which the photosensitive layer or the like of the optical element is formed so that the photosensitive layer or the protective layer is not exposed.

As a material for forming the outer shell layer, a material capable of inhibiting leakage of the components of the photosensitive layer and the protective layer from leaking out due to elution or the like can be suitably used. Examples thereof include inorganic materials such as SiO₂, TiO₂, Al₂O₃, and SiNₓ. These inorganic materials may be used alone or as a mixture of a plurality of compounds in combination.

As a method for forming the outer shell layer, a known film forming method or the like can be suitably used. For example, in a case where the inorganic material listed above is used as the outer shell layer, the outer shell layer can be suitably formed by a known method such as a vapor deposition method, an ion plating method, a sputtering method, a plasma CVD method, a thermal CVD method, or an ALD method.

In the optical element according to the present technology, since an outer shell layer having a lower gas permeability than that of the base material layer is provided between functional layers such as the photosensitive layer and the base material layer, it is possible to suppress the low molecular weight compound in the functional layer from oozing out of the optical element due to elution or the like.

In the optical element according to the present technology, as described above, the base material layer is a layer capable of supporting a functional layer such as the photosensitive layer, but in a case where the base material layer constitutes the outer edge of the optical element, it may not necessarily be possible to suitably seal components contained within the base material layer, depending on the nature of those components. For example, in a case where a functional layer such as a photosensitive layer contains materials whose biocompatibility has not been confirmed through biological impact verification tests such as animal testing or human testing, it is preferable, from the viewpoint of a safety standpoint, to suppress the leakage of such materials to the outside of the optical element. As a result, even though the optical element according to the present technology is used for a product such as a contact lens coming into contact with a mucous membrane or the like having high absorbability into the interior, the safety of the product can be suitably enhanced.

In a case where the optical element has a configuration in which one or more functional layers containing a low molecular weight compound are provided in the base material layer, the outer shell layer, provided between the functional layer and the base material layer, has a lower gas permeability than the base material layer. Therefore, it possible to suitably suppress oozing of the low molecular weight compound contained in the functional layer to the outside of the optical element.

Here, the “functional layer” includes a layer provided to impart any function according to the application or purpose of the optical element according to the present technology. Examples of the functional layer include the above-described photosensitive layer, a semiconductor layer, a biological reaction layer containing a compound that reacts with a substance in a living body, and electric wiring.

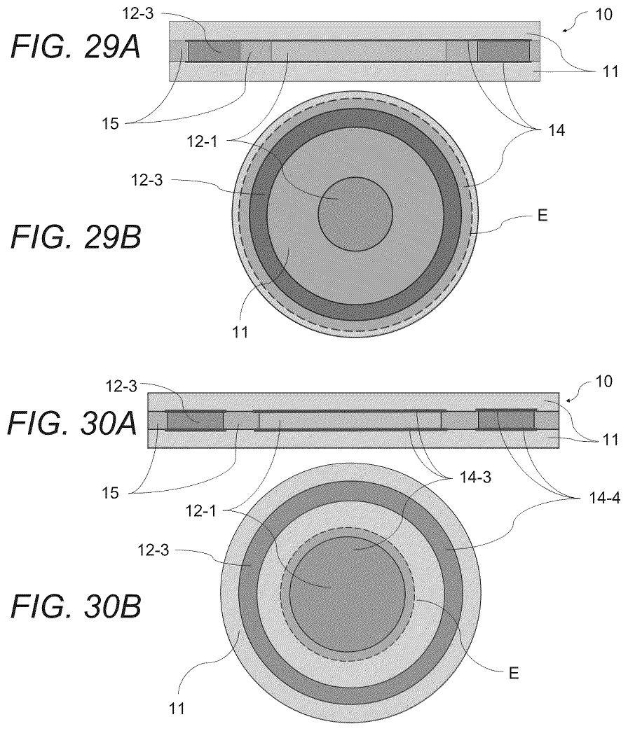

In the optical element according to the above-described configuration, a plurality of functional layers may be provided in the base material layer according to the use and purpose of the optical element. In this case, a plurality of functional layers may be provided in series along an axis through which light passes when used as the optical element as in an example of an optical element illustrated in FIG. 32 and the like as described later, or one or more other functional layers may be provided on a periphery or the like of one functional layer as in an example of an optical element illustrated in FIG. 29 and the like. Furthermore, the configuration in which these are combined may be adopted. Moreover, the functional layer provided in the base material layer may have a configuration in which a layer other than the functional layer, such as a barrier layer, an insulating layer, or an electromagnetic shielding layer, is added.

In the optical element having the above-described configuration, in a case where a plurality of functional layers is provided in the base material layer and the plurality of functional layers is arranged in series along the axis through which light passes when used as the optical element, as in the example of the optical element illustrated in FIG. 32 and the like as described later, two or more of the functional layers may be directly bonded to each other, or may be configured not to be directly bonded to each other. In the case where the two or more functional layers are not directly bonded to each other, it is also possible to adopt a configuration in which the two or more functional layers are bonded to each other with an intermediate layer interposed therebetween, such as the above-described barrier layer, insulating layer, or electromagnetic shielding layer, which is not a functional layer. The intermediate layer may be a single layer or two or more layers.

The “low molecular weight compound” contained in the functional layer is a low molecular weight compound present in the functional layer. The compound is not particularly limited, but for example, a material or the like whose biocompatibility has not been confirmed by a confirmation test of an influence on a living body, such as an animal test or a human body test, is assumed. More specific examples include, for example, in a case where the functional layer is a photosensitive layer, an unreacted monomer remaining in the photosensitive layer, a compound related to a solvent, a photosensitizing substance, a gas generated during a reaction at the time of forming the photosensitive layer, and the like.

Furthermore, the “gas permeability” refers to a speed at which a gas passes through a target layer. The gas is not particularly limited as long as it is a gaseous low molecular weight compound. For example, water vapor or the like can be used as an index of the permeability. In a case where water vapor is used as an index, the gas permeability is water vapor permeability.

The outer shell layer can be suitably configured by combining a single or a plurality of materials or adjusting the thickness so as to have a lower gas permeability than the base material layer. Furthermore, the outer shell layer may be configured to achieve the above-described function by laminating a plurality of the same or different layers.

The outer shell layer is preferably formed mainly of a material having low gas permeability. Examples of such materials include, in addition to the aforementioned Compounds, highly transparent inorganic compounds such as zirconium oxide, indium oxide, tin oxide, yttrium oxide, niobium oxide, tantalum oxide, hafnium oxide, indium oxide (In2O3), aluminum nitride, tantalum nitride, zirconium nitride, hafnium nitride, tungsten nitride, vanadium nitride, tungsten silicide nitride, titanium silicide nitride, zirconium oxide, zirconium silicate, zirconium barium oxide, zirconium hafnium oxide, indium tin oxide (ITO), stannous tin oxide (STO), aluminum-doped tin oxide (ATO), and polymer compounds such as polyacrylic acid (PAA), hydrocarbons, and carbon. The outer shell layer can be formed by combining a single material or a plurality of materials in accordance with the base material layer adopted by the optical element.

For the purpose of suitably sealing the components in the base material layer, in a case where the optical element has the above-described configuration, a plurality of outer shell layers may be provided in accordance with the surface constituting the functional layer. For example, by providing two or more outer shell layers to sandwich the functional layer in accordance with the front side and the back side of the main surface of the functional layer, it is possible to more suitably suppress the low molecular weight compound in the functional layer from oozing out of the optical element.

In a case where the optical element has the above-described configuration for the purpose of suitably sealing the components the inside of the base material layer, the base material layer may include two base material layers, and the inside may be sandwiched between the two base material layers. In this case, the outer shell layer may be provided on each of two surfaces of the functional layer facing the base material layer.

In the optical element of the present technology, in a case where the outer shell layer is provided on each of two surfaces of the functional layer facing the base material layer, the outer shell layers may have mutually different permeabilities in accordance with the purpose, application, and use form of the optical element. In this case, for the outer shell layers, for example, by changing any requirements such as the material for forming the outer shell layer or the thickness and configuration (combination of lamination and the like) of the outer shell layer to different requirements, configurations with different gas permeabilities can be achieved. In a case where the optical element has the present configuration, for example, in the manufacturing process of the optical element, it is possible to suitably reduce thickness unevenness of the functional layer by using a material having high wettability with the functional layer for the outer shell layer provided over the base material layer where the functional layer is formed by coating or the like.

In a case where the optical element has the above-described configuration for the purpose of suitably sealing the components in the base material layer, the optical element may further include an adhesive layer described later, and the functional layer may be sealed with the adhesive layer. In this case, in a region where the outer shell layer is not provided between the surface of the functional layer included in the optical element and the surface of the optical element, a material for forming the adhesive layer is filled between the functional layer and the surface of the optical element. Therefore, even in the region, oozing of the low molecular weight compound contained in the functional layer to the outside of the optical element can be suitably suppressed.

In a region where the outer shell layer is not provided between the surface of the functional layer included in the optical element and the surface of the optical element, the longer the distance over which the material for forming the adhesive layer is filled, the more the gas permeability in that region can be expected to be reduced. In this case, the distance over which the material for forming the adhesive layer is filled can be designed to be shorter as the gas permeability of the compound or composition used as the material for forming the adhesive layer increases.

Furthermore, in a case where the outer shell layer is provided on the surface of the optical element for the purpose of suitably sealing the components contained in the base material layer, as illustrated in embodiments described later, the outer shell layer is disposed to cover the main surface of the functional layer. Therefore, by designing the distance over which the material for forming the adhesive layer is filled, from the peripheral portion of the region where the functional layer is formed to the outer edge of the surface of the optical element, to be longer, oozing of the low molecular weight compound contained in the functional layer to the outside of the optical element can be suitably suppressed even in the region where the outer shell layer is not provided. In this case, in the region where the outer shell layer is not provided between the surface of the functional layer included in the optical element and the surface of the optical element, the adhesive layer can be designed to seal between the functional layer and the surface of the optical element over a range of, for example, 1.0 μm or more, 100 μm or more, or 1.0 mm or more.

In a case where the optical element adopts the above-described configuration for the purpose of suitably sealing the components contained in the base material layer, the functional layer and the outer shell layer may be directly bonded to each other, or may be configured not to be directly bonded to each other. Furthermore, with the combination of both configurations, for example, for one main surface of the functional layer, the functional layer and the outer shell layer may be directly bonded to each other, and for the other main surface of the functional layer, the functional layer and the outer shell layer may be configured not to be directly bonded to each other.

For the purpose of suitably sealing the components in the base material layer, in a case where the optical element has the above-described configuration, a facing face of the base material layer that faces the functional layer is usually designed to be larger than a facing face of the functional layer that faces the base material layer. In this case, the outer shell layer may be formed over the entire surface of the facing face of the base material layer that faces the functional layer. By forming the outer shell layer over the entire surface of the facing surface facing the functional layer of the base material layer, it is possible to suitably suppress the low molecular weight compound in the functional layer from oozing out of the optical element.

On the other hand, a configuration in which a region where the outer shell layer is not formed on the facing surface of the base material layer that faces the functional layer may be adopted. In this configuration, since the region where the outer shell layer is not formed has gas permeability as compared with the region where the outer shell layer is formed, the arrangement of the region can be designed according to the purpose and use of the optical element. For example, in a case where the optical element according to the present technology is used in a contact lens, the functional layer may be disposed near the pupil, the outer shell layer may be formed in the vicinity of the functional layer, and a region where the outer shell layer is not formed may be disposed at the peripheral portion of the functional layer, thereby ensuring favorable permeability to gases such as oxygen in the region. That is, the above-described region can be suitably designed in consideration of the purpose of the optical element, taking into account the balance between suppression of oozing of components from the functional layer to the outside and the gas permeability as the optical element.

In the configuration in which the region where the outer shell layer is not formed is provided with the form in which the plurality of functional layers is provided such that another functional layer is provided on the periphery or the like of one functional layer, as in the example of the optical element shown in FIG. 29 and the like described later, the outer shell layer may be independently provided for each functional layer, or a single continuous outer shell layer may be disposed between the plurality of functional layers and the base material layer.

In a case where the plurality of functional layers is provided in the form in which another functional layer is provided at the periphery or the like of one functional layer, as in the example of the optical element illustrated in FIG. 29 as described later, it is possible to design the optical element, for example, in accordance with the intended use thereof, such that a functional layer having low transparency is disposed at the peripheral portion.

Note that in a case where the optical element according to the present technology is used in a contact lens, for example, and the outer diameter of the contact lens is 10 mm (with a radius of 5 mm) and the outer diameter of the functional layer disposed near the pupil is 6 mm (with a radius of 3 mm), the above-described balance can be achieved in accordance with the intended purpose of the optical element by designing the outer edge of the outer shell layer within any range from the outer edge of the functional layer to the outer edge of the contact lens (the range of a radius more than 3 mm and up to a radius of 5 mm)

For the purpose of suitably sealing the components in the base material layer, even in the case where the optical element includes the outer shell layer having a lower gas permeability than that of the base material layer between the functional layer and the base material layer, the configurations described in the present specification can be optionally combined and used.

### Contact Layer

In a case where the optical element according to the present technology is used for a product in contact with a user, such as a contact lens, a contact layer covering the entire surface of the optical element may be further provided. In the present technology, the “contact layer” refers to a layer that covers the entire surface of the optical element to form a surface exposed to the outside of the optical element. Note that, in the present technology, in a case where the base material layer covers the entire surface of the optical element, the base material layer also serves as a contact layer.

In a case where the optical element according to the present technology has a contact layer, a user of the optical element is in contact with the optical element via the contact layer. Therefore, by using a highly safe material for the contact layer, the safety of the product including the optical element according to the present technology can be enhanced. In particular, in a case of being used in products such as a contact lens that comes into contact with a mucous membrane or the like having high absorption into the body, it is preferable to include the contact layer.

As a material for forming the contact layer, a material having less influence on a human body or the like can be suitably used. Specifically, a material or the like whose biocompatibility has been confirmed by a confirmation test of an influence on a living body, such as an animal test or a human body test, can be suitably used. Examples thereof include siloxane-containing methacrylate-based compounds, silicon-containing methacrylate-based compounds, acrylamide-based compounds, and compounds such as 2-HEMA, MAA, N,N-dimethylacrylamide, and N-vinylpyrrolidone, which are materials used for known contact lenses and the like. These compounds may be used alone or as a mixture of a plurality of compounds in combination.

The above-described contact layer may contain any colorant or ultraviolet absorber. As the colorant, a known material that can be used as a material such as a contact lens can be used, and examples thereof include an anthraquinone-based colorant and a phthalocyanine-based colorant. Furthermore, as the ultraviolet absorber, a known material that can be used as a material such as a contact lens can be used, and examples thereof include a benzotriazole-based ultraviolet absorber.

The method for forming the contact layer can suitably employ known film-forming methods, and examples thereof include methods such as shaping by impregnating the base material layer or the like with physiological saline, molding methods using molds such as mold forming, and methods involving formation by coating.

### Adhesive Layer

The optical element according to the present technology may further include an adhesive layer. Here, the “adhesive layer” is a layer provided between any two layers (at the interface or the like) included in the laminated film and bonds the two layers.

In the optical element according to the present technology, the position of the adhesive layer is not limited, and by providing the adhesive layer between any two layers, the adhesive strength of the two layers can be enhanced.

In the optical element according to the present technology, the material for forming the adhesive layer can be selected to suitably bond the respective materials in accordance with the characteristics of the materials constituting the two layers to be reinforced in terms of adhesion strength, as well as the characteristics of the materials constituting the surfaces of the members to be bonded. Furthermore, in the case of an optical element having a surface coming into contact with a user, it is preferable to use a material whose biocompatibility has been confirmed as a material for forming the adhesive layer from the viewpoint of safety to a living body. Examples of the material whose biocompatibility has been confirmed include parylene and polyimide, but are not limited to these materials. The adhesive layer may be a layer including a single compound or may be a layer including a composition containing a plurality of compounds.

In the optical element according to the present technology, the thickness of the adhesive layer can be appropriately selected as any desired thickness in accordance with the characteristics of the materials constituting the two layers to be reinforced in terms of adhesion strength.

As described above, even in a case where the optical element includes the outer shell layer having a lower gas permeability than that of the base material layer between the functional layer and the base material layer for the purpose of suitably sealing components contained in the base material layer, the above-described materials and conditions can be suitably used as the material for forming the adhesive layer.

### Other Layers

The optical element according to the present technology may contain other layers in addition to those described above, as necessary, as long as desired various physical properties are not significantly impaired. Examples of other layers include layers having functions such as antireflection, filters that remove any specific wavelengths by absorption or reflection, filters that attenuate the amount of transmitted light, and polarizing filters, as well as barrier layers, insulating layers, and electromagnetic shielding layers.

Since the present technology enables formation of the photosensitive layer regardless of shape, interference fringes can be suitably recorded even in the optical element included in an optical device such as a contact lens, an eyeglass lens, an optical lens used in a camera, and a display device. Here, the optical device provided with the optical element according to the present technology includes not only an optical device in which the optical element according to the present technology is incorporated into a part such as a lens by a method such as attachment, but also an optical device in which the optical element is integrated with the device, as well as a case in which the optical element itself constitutes the optical device, such as the contact lens illustrated in an eleventh embodiment to a thirteenth embodiment as described later.

Furthermore, a system including the optical device including the optical element of the present technology and the external device can also be used. The external device may be a display system combined with a projection system such as a video projection device, an information system combined with various information devices, a visual assistance system combined with a detection device, or the like, or a sensing system combined with another optical device in addition to the detection device or the like. The external device and the system combined with the external device described above are merely examples, and the system can be constructed by combining the optical element according to the present technology and any external device according to the purpose of the system.

Specific examples of the above-described system include a display system including an optical device such as a contact lens including the optical element according to the present technology and a projection system.

Hereinafter, a specific embodiment of an optical element according to the present technology will be described with reference to the drawings. Note that the following embodiments are examples of embodiments of the present technology, and the present technology is not to be construed as being limited to the contents of these embodiments at all.

### 1 First Embodiment

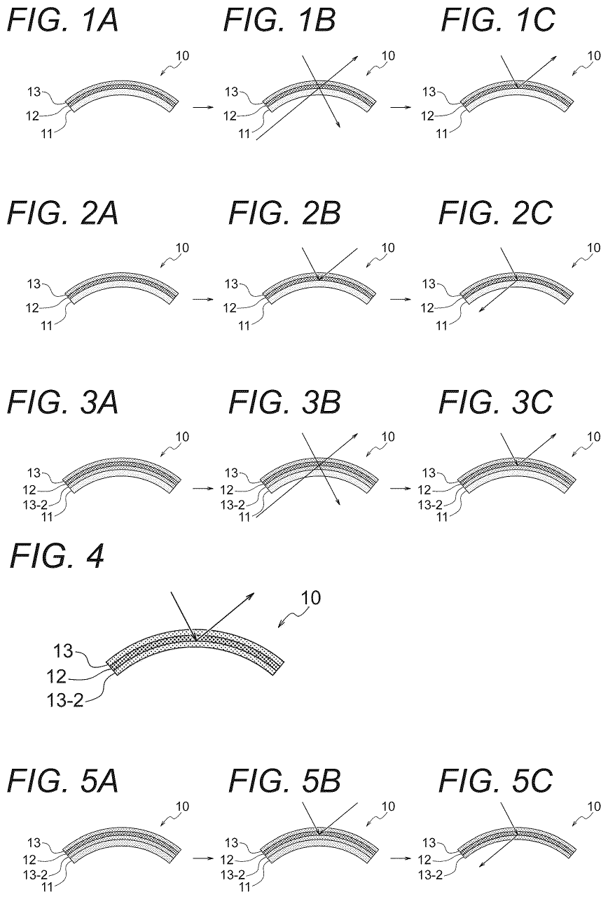

FIG. 1A illustrates an example of an optical element according to a first embodiment and a method for manufacturing the optical element. An optical element 10 according to the present embodiment is an optical element (optical element before exposure) formed such that a photosensitive layer 12 is formed on a convex surface of a base material layer 11 having a curved surface shape with a photosensitive layer-forming solution, and a protective layer 13 is formed with a protective layer-forming solution. Note that, although FIG. 1A illustrates an example in which the photosensitive layer and the protective layer are formed on the convex surface of the base material layer having a curved surface shape, the photosensitive layer and the protective layer can also be formed on the concave surface of the base material layer having a curved surface shape as in the example illustrated in a sixth embodiment described later. Furthermore, although FIG. 1A illustrates an example in which the base material layer and the photosensitive layer are adjacent to each other, the base material layer and the photosensitive layer may not be adjacent to each other as in an example illustrated in a third embodiment described later.

Note that the optical element according to the embodiment illustrated in the drawings in the present specification including the first embodiment will be described using an example of an optical element having a curved surface shape on the basis of the characteristics of the present technology that the photosensitive layer and the protective layer can be suitably formed even on a base material layer that is not in a planar shape. However, the shape of the optical element is not limited to a curved surface shape or the like, and may be a planar shape.

Since the optical element illustrated in FIG. 1A is before exposure, the photosensitive layer 12 contains a photosensitizing substance and a photosensitizing polymerizable monomer, and the protective layer 13 contains a protective polymer soluble in a protective layer solvent that does not dissolve the photosensitive layer, and a compound related to the protective layer solvent.

The base material layer 11 in the present embodiment is a layer that can secure the strength of the entire optical element according to the application of the optical element 10. The material for forming the base material layer in the present embodiment is not particularly limited as long as the material can secure the strength of the entire optical element according to the application of the optical element. For example, from the viewpoint of recording interference fringes and the like, it is preferable to use a material having high light transmittance and low oxygen permeability. Examples of such a material include, for example, a material that can be used as a base material of a contact lens, such as silicon-containing methacrylate (SiMA), fluorine-containing methacrylate (EMA), poly(2-hydroxyethyl methacrylate) (P-HEMA), and silicone hydrogels (such as TRIS and SIGMA), a polymer compound such as a polycarbonate-based resin, a polyester-based resin, or a cellulose-based resin, or the like can be suitably used. The substrate layer may be a layer including a single compound or may be a layer including a composition containing a plurality of compounds.

In a case where the base material layer contains two or more compounds, the two or more compounds may be mixed, the two or more compounds may be copolymerized, or the two or more compounds may be laminated to form a laminated film.

In the optical element in the present embodiment, as the thickness of the base material layer, any thickness can be appropriately selected according to the application of the optical element 10, but from the viewpoint of transparency and rigidity of the optical element 10, the thickness is preferably 0.1 μm or more, more preferably 1 μm or more, and still more preferably 3 μm or more. The upper limit of the thickness of the substrate layer is not particularly limited, but can be suitably adjusted within a range of, for example, 200 μm or less, more preferably 150 μm or less, and still more preferably 70 μm or less.

The base material layer may include a coat-treated layer as necessary. The coat-treated layer improves interface characteristics with the base material layer in a case where the photosensitive layer or the protective layer or the outer shell layer or the contact layer is formed on the base material layer, or improves peelability of the protective layer from the base material layer. The coat-treated layer may be provided on both of a first surface and a second surface of the base material layer or on one surface of the base material layer. The coat-treated layer contains, for example, an ultraviolet curable resin. The coat-treated layer may contain an additive such as fine particles as necessary.

In the optical element in the present embodiment, in order to record interference fringes as a hologram that controls a light beam by reflection and diffraction of incident light on the photosensitive layer, a material having high light transmittance is used as a material of the base material layer.

FIG. 1B illustrates an example of a process of producing a hologram by interference exposure on the basis of the optical element before exposure illustrated in FIG. 1A.

The optical element 10 is irradiated with interference light. As a result, in the photosensitive layer 12, the energy of light absorbed by the photosensitizing substance is transmitted to a reactant such as a polymerization initiator or a photosensitizing polymerizable monomer according to the amount of light irradiation, and the polymerization reaction of the photosensitizing polymerizable monomer proceeds. On the other hand, since the polymerization reaction does not proceed in a region where the amount of light irradiation is small, a concentration gradient of the polymer of the photosensitizing polymerizable monomer occurs, and a phase separation structure is formed in the photosensitive layer 12.

The formation of the phase separation structure increases the refractive index difference between the separated phases in the photosensitive layer 12, and the refractive index modulation degree An is improved.

Note that the conditions of two-beam exposure at the time of irradiation with interference light may be appropriately set by those skilled in the art according to the application, purpose, and the like of the hologram optical element. For example, the light intensity of the single light flux on the hologram recording medium is set to 0.1 mW/cm2 or more and 100 mW/cm2 or less, and the exposure condition for 1 second or more and 1000 seconds or less can be appropriately adjusted. Furthermore, interference exposure can be performed such that the angle formed by the two light fluxes is 0 degrees or more and 179.9 degrees or less.

For the irradiation with the above-described interference light, the optical element were irradiated with object light and reference light that cause the hologram to interfere from different directions, and the photosensitive layer 12 was directly exposed without using an oxygen exclusion system. As a result, the photosensitive layer 12 is an optical element in which interference fringes as a hologram for controlling light beams by reflection and diffraction of incident light are recorded.

The optical element according to the present technology may further perform a UV exposing step after an interference exposing step.

In the UV exposing step, the entire optical element 10 subjected to the interference exposure is irradiated with UV. The polymerization initiator is excited by UV irradiation, and the polymerization reaction of the plasticizer and the photosensitizing polymerizable monomer contained in the photosensitive layer proceeds. As the polymerization reaction proceeds, the phase separation structure formed inside the photosensitive layer 12 is fixed, and the interference fringes generated by the interference light can be suitably recorded.

The optical element according to the present technology may further perform a heating step after the UV exposing step.

In the heating step, the entire optical element 10 subjected to the UV exposure is heated to promote the polymerization reaction of the unreacted photosensitizing polymerizable monomer and plasticizer. Therefore, the photosensitizing polymerizable monomer and plasticizer are diffused in the photosensitive layer 12. As a result, further phase separation proceeds by the polymerization reaction using the existing phase separation structure as a nucleus.

Therefore, the refractive index difference between the phases further increases and the refractive index modulation degree Δn is improved.

The photosensitive layer 12 of the optical element 10 subjected to the interference exposure described above contains the derivative of the photosensitizing substance and the polymer of the photosensitizing polymerizable monomer by the photochemical reaction upon the interference exposure.

FIG. 1C illustrates an optical element as a hologram in which interference fringes are recorded in the optical element before exposure illustrated in FIG. 1A. The optical element according to the present embodiment can control light beams by reflection diffraction of an incident light beam. That is, as illustrated in FIG. 1C, the incident light beam can be reflected and diffracted in an arbitrary direction. Therefore, the optical element functions as an optical element having a high degree of freedom in light beam control. Here, the light beams used for interference exposure to record interference fringes are not limited to two parallel light beams. One of the beams may be a parallel beam, and the other may be a convergent or divergent beam, thereby the optical element functioning similarly to a lens.

In a case where reflected light is used as in the present embodiment, the occurrence of a phenomenon in which diffracted light is generated by light incident from an unintended angle (so-called “rainbow”) can be reduced.

### 2 Second Embodiment

FIG. 2A illustrates an example of an optical element according to a second embodiment and a method for manufacturing the optical element. In the optical element 10 according to the present embodiment, a material and a configuration that can be used for the optical element according to the first embodiment can also be suitably used in the present embodiment. Furthermore, in the present embodiment, since the object light and the reference light are emitted to the optical element from the same direction as described later, a material having low light transmittance can also be used as the material of the base material layer.

FIG. 2B illustrates a process of producing a hologram by interference exposure based on the optical element before exposure illustrated in FIG. 2A. For this process, the interference exposing step that can be adopted in the first embodiment can be used. However, in the present embodiment, for irradiation with interference light, object light and reference light that cause interference with a hologram are emitted to the optical element from the same direction, and the photosensitive layer 12 is directly exposed without using an oxygen exclusion system. As a result, the light incident on the photosensitive layer 12 is diffracted in the transmission direction, and interference fringes for controlling the light are recorded. As the other interference exposure conditions, the interference exposure conditions described in the first embodiment can also be suitably used in the present embodiment.

FIG. 2C illustrates an optical element as a hologram in which interference fringes are recorded in the optical element before exposure illustrated in FIG. 2A. The optical element according to the present embodiment can control light beams by diffraction of incident light in the transmission direction.

In a case where transmitted light is used as in the present embodiment, since the range of incidence angles of incident light that can be utilized is wide (that is, the incident angle characteristic is broad), diffracted light can be reproduced by utilizing light incident over a wide range.

### 3 Third Embodiment

FIG. 3A illustrates an example of an optical element according to a third embodiment and a method for manufacturing the optical element. The optical element 10 according to the present embodiment is an optical element (optical element before exposure) formed such that a second protective layer 13-2 is formed on a convex surface of a base material layer 11 having a curved surface shape with a protective layer-forming solution, a photosensitive layer 12 is formed with a photosensitive layer-forming solution, and a first protective layer 13 is formed thereon with a protective layer-forming solution.

In the present embodiment, the material for forming the base material layer, the photosensitive layer, and the first and second protective layers may preferably be the similar types of materials as those that can be used for the base material layer, the photosensitive layer, and the protective layer of the optical element according to the first embodiment. However, in consideration of the peeling or adhesion strength between the surface on which the protective layer-forming solution is applied and a layer formed adjacent to the protective layer after formation, it is also possible to adjust the components of the protective layer-forming solution for forming the first protective layer 13 and the components of the protective layer-forming solution for forming the second protective layer 13-2 to be different from each other (in other words, the protective layer-forming solution for forming the first protective layer 13 and the protective layer-forming solution for forming the second protective layer 13-2 may be the same as or different from each other). Furthermore, the configuration that can be used for the optical element according to the first embodiment may also be suitably used in the present embodiment.

FIG. 3B illustrates a process of producing a hologram by interference exposure based on the optical element before exposure illustrated in FIG. 3A. The process can more suitably produce a hologram by the interference exposing step that can be adopted in the first embodiment.

FIG. 3C illustrates an optical element as a hologram in which interference fringes are recorded in the optical element before exposure illustrated in FIG. 3A. Although the optical element according to the present embodiment is an example that, similarly to the example of the first embodiment, can control light beams by reflecting and diffracting light incident on the optical element, as in the example illustrated in the second embodiment, light beams can also be controlled by diffracting the light incident on the optical element in the transmission direction by irradiation with interference light in the interference exposing step such that both object light and reference light are emitted to the optical element from the same direction.

### 4 Fourth Embodiment

FIG. 4 illustrates an example of the optical element according to the third embodiment from which a base material layer has been removed by peeling. The optical element 10 according to the present embodiment can be manufactured by separating a base material layer 11 from the optical element 10 by peeling at the interface between the base material layer 11 and the second protective layer 13-2 of the optical element according to the third embodiment. Note that, in FIG. 4, in order to record the interference fringes enabling control of light beams by reflecting and diffracting the incident light on the photosensitive layer, an example of interference light irradiation is illustrated in which a material having high light transmissivity is used as a material for the base material layer, and the object light and the reference light are emitted to the optical element from different directions for irradiation with the interference light in the interference exposing step, but the present embodiment is not limited thereto. In the irradiation of the interference light in the interference exposing step, the object light and the reference light are emitted to the optical element from the same direction, and the incident light is diffracted in the transmission direction to record the interference fringes for controlling the light on the photosensitive layer.

Since the optical element according to the present embodiment has a film shape in which the base material layer capable of securing the strength of the entire optical element is separated, the optical element can be processed into any shape by means such as cutting. Moreover, by transferring the processed optical element to another member, a function of a hologram can be imparted to a member having any shape.

### 5 Fifth Embodiment

FIG. 5 illustrates a modification of an optical element according to a fourth embodiment. In FIG. 5A, a material having low optical transparency was used as the material for the base material layer to be separated from the optical element by peeling in the fourth embodiment, and for irradiation with interference light in the interference exposing step, object light and the reference light were emitted to the optical element from the same direction. Other than this, the optical element of the present embodiment can be suitably produced by a method similar to the method for manufacturing an optical element used in the fourth embodiment, and materials and configurations that can be used for the optical element according to the fourth embodiment can be suitably used in the present embodiment. Furthermore, an effect similar to that of the optical element according to the fourth embodiment is obtained except that interference fringes that diffract the light incident on the photosensitive layer 12 in the transmission direction and control the light are recorded.

### 6 Sixth Embodiment

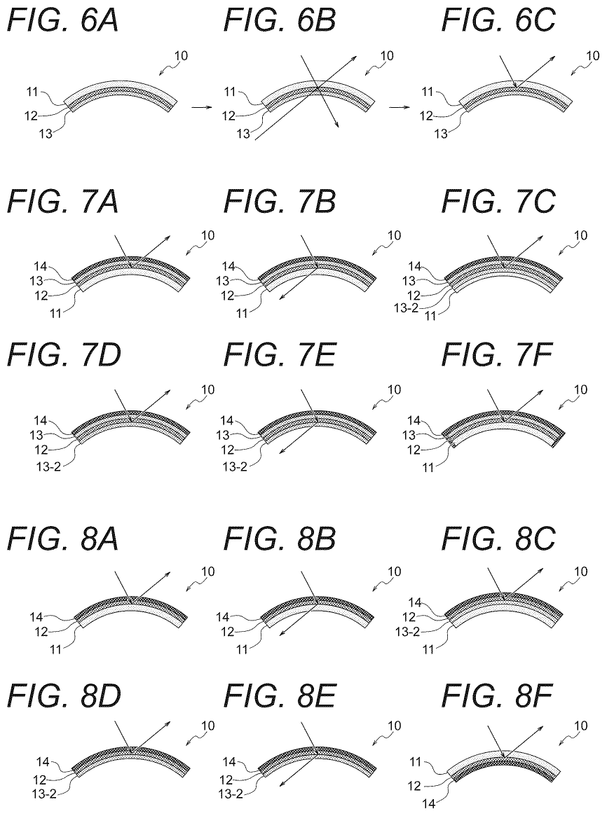

FIG. 6 illustrates a modification of the optical element and the method for manufacturing the optical element according to the first embodiment. While the optical element according to the first embodiment is manufactured as an optical element before exposure by forming a photosensitive layer and a protective layer on a convex surface of a base material layer having a curved surface shape, the optical element 10 according to the present embodiment is manufactured as an optical element before exposure by forming the photosensitive layer 12 and the protective layer 13 on a concave surface of the base material layer 11 having a curved surface shape. Other than this, the optical element of the present embodiment can be suitably produced by a method similar to the method for manufacturing an optical element used in the first embodiment, and materials and configurations that can be used for the optical element according to the first embodiment can be suitably used in the present embodiment.

Note that, in FIG. 6C, in order to record interference fringes as a hologram that controls the light beams by reflecting and diffracting the incident light on the photosensitive layer, an example of interference light is illustrated in which a material having high light transmissivity is used as a material of the base material layer, and the object light and the reference light are emitted to the optical element from different directions for irradiation with interference light in the interference exposing step, but the present embodiment is not limited thereto. For irradiation with the interference light in the interference exposing step, object light and reference light are emitted to the optical element from the same direction, and the incident light is diffracted in the transmission direction to record the interference fringes as a hologram for controlling the light on the photosensitive layer.

### 7 Seventh Embodiment

FIG. 7 illustrates an example in which each of the optical elements according to the aforementioned first to fifth embodiments includes an outer shell layer covering at least a part of a surface of each optical element. The correspondence between the optical elements illustrated in FIGS. 7A to 7F and the optical elements according to the first to fifth embodiments is illustrated below.

FIG. 7A is an example in which an outer shell layer is provided on a convex surface of the optical element according to the first embodiment.

FIG. 7B is an example in which an outer shell layer is provided on a convex surface of the optical element according to the second embodiment.

FIG. 7C is an example in which an outer shell layer is provided on a convex surface of the optical element according to the third embodiment.

FIG. 7D is an example in which an outer shell layer is provided on a convex surface of the optical element according to the fourth embodiment.

FIG. 7E is an example in which an outer shell layer is provided on a convex surface of the optical element according to the fifth embodiment.

FIG. 7F illustrates a modification of the example in which an outer shell layer is provided on the convex surface of the optical element according to the first embodiment, and in this modification, the outer shell layer is formed to cover not only the convex surface of the optical element but also side surfaces thereof.

In the above-described example illustrated as the present embodiment, the outer shell layer is illustrated as an example of a configuration in which the convex surface of the optical element is covered, serving as a layer that efficiently inhibits leakage of components of the photosensitive layer and the protective layer, but it may also be configured to cover all the surfaces of the optical element. Furthermore, as a material for forming the outer shell layer used in the present embodiment, for example, the above-described inorganic materials can be suitably used, and these inorganic materials can be preferably formed by the above-described known methods. Moreover, except for the outer shell layer, the optical element of the present embodiment can be suitably produced by a method similar to the method for manufacturing the optical element used in each corresponding embodiment, and materials and configurations that can be used for the optical element according to each corresponding embodiment can also be suitably used in these embodiments.

### 8 Eighth Embodiment

FIG. 8 illustrates a modification of the example in which each of the optical elements according to the aforementioned first to fifth embodiments includes an outer shell layer covering at least a part of a surface of each optical element. In these embodiments, after the photosensitive layer is formed, an outer shell layer is formed instead of the protective layer. The correspondence between the optical elements illustrated in FIGS. 8A to 8F and the optical elements according to the first to fifth embodiments is illustrated below.

FIG. 8A is an example in which an outer shell layer is provided on a convex surface of the optical element according to the first embodiment.

FIG. 8B is an example in which an outer shell layer is provided on a convex surface of the optical element according to the second embodiment.

FIG. 8C is an example in which an outer shell layer is provided on a convex surface of the optical element according to the third embodiment.

FIG. 8D is an example in which an outer shell layer is provided on a convex surface of the optical element according to the fourth embodiment.

FIG. 8E is an example in which an outer shell layer is provided on a convex surface of the optical element according to the fifth embodiment.

FIG. 8F illustrates a modification of the example in which an outer shell layer is provided on the convex surface of the optical element according to the first embodiment, and in this modification, the outer shell layer is formed to cover not only the convex surface of the optical element but also side surfaces thereof.

In these embodiments, except for the formation of the outer shell layer in place of the protective layer after forming the photosensitive layer, the optical element of the present embodiment can be suitably produced by a method similar to the method for manufacturing the optical element used in each corresponding embodiment, similar to that in the case of the seventh embodiment, and materials and configurations that can be used for the optical element according to each corresponding embodiment can also be suitably used in these embodiments.

### 9 Ninth Embodiment

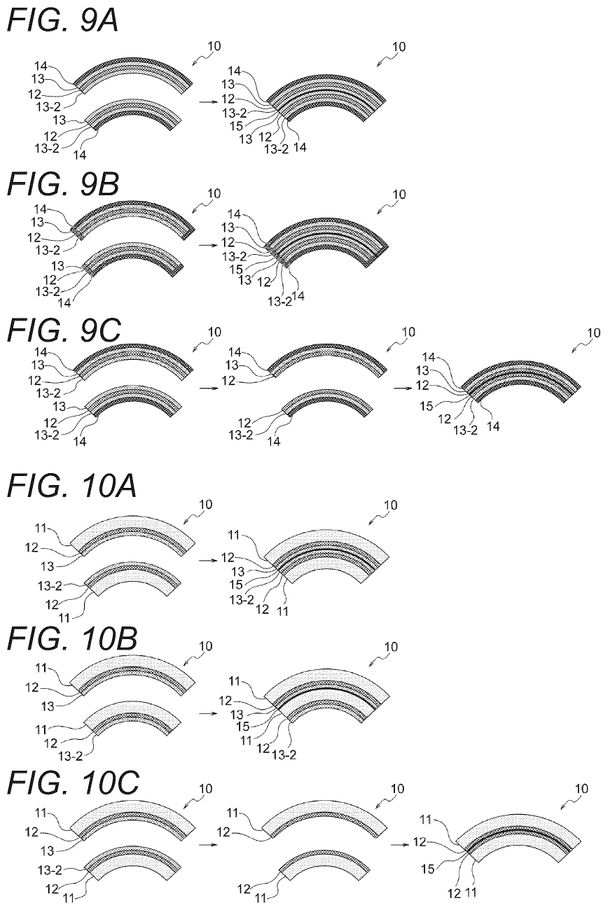

FIGS. 9 to 11 illustrate modifications of the method for producing a hologram using the optical element according to the present technology. Each can be manufactured by bonding two optical elements each including a photosensitive layer on which interference fringes are recorded. Since two photosensitive layers are provided, for example, interference fringes as a reflective hologram for deflection can be recorded in one of the photosensitive layers, and interference fringes as a reflective hologram for a lens can be recorded in the other photosensitive layer. In this manner, by combining two optical elements having different functions, the optical elements are very thin while still performing multiple functions.

Note that, in the present embodiment, the adhesive layer may also be used to bond the two optical elements together. In a case where the adhesive layer is used, the adhesive layer may be provided on the bonding surface of either one of the optical elements, or may be provided on the bonding surfaces of both optical elements.

Note that, from an optical standpoint, in a case where the number of layers increases, the incident light may be reflected at the interfaces of the layers, or scattering or absorption may occur due to materials contained in the layers. Therefore, it is preferable that the number of layers constituting the optical element is small. Accordingly, in a case of an increase in the number of layers, such as bonding two optical elements each provided with a photosensitive layer in which interference fringes have been recorded, the optical characteristics of the optical element can be improved by methods such as removing unnecessary layers by peeling, elution using a solvent, or adjusting the layer thickness by polishing or cutting. Here, “polishing” refers to grinding to smooth the surface, and “cutting” refers to cutting.

FIG. 9 illustrates an optical element manufactured by bonding two optical elements selected from optical elements, each being obtained by removing the base material layer illustrated in the fourth or fifth embodiment by peeling. FIG. 9A illustrates a method for manufacturing an optical element by bonding the optical element provided with the outer shell layer on the convex surface and the optical element provided with the outer shell layer on the concave surface. FIG. 9B illustrates a method for manufacturing an optical element by bonding the optical element provided with the outer shell layer covering not only the convex surface but also the side surface, and the optical element provided with the outer shell layer covering not only the concave surface but also the side surface. FIG. 9C illustrates a method for manufacturing an optical element by bonding the two optical elements illustrated in FIG. 9A after removing the two protective layers (the first protective layer 13 and the second protective layer 13-2) that face each other at the bonding surfaces. In this case, by removing the two protective layers, the number of layers constituting the optical element can be reduced, and the occurrence of reflection at the interface of the layers and scattering and absorption in the layers can be suppressed. As a method for removing the above-described protective layer, any method such as removal by elution using a solvent or removal by peeling can be used.

In the optical element illustrated in FIG. 9, from the viewpoint of enhancing the safety of the product including the optical element according to the present technology, an example of the optical element including the outer shell layer that inhibits leakage of the components of the photosensitive layer and the protective layer is illustrated, but the present technology is not limited to the form of the optical element including the outer shell layer.

FIG. 10 illustrates an optical element manufactured by bonding two optical elements selected from optical elements illustrated in the first to third embodiments or the sixth embodiment. FIG. 10A illustrates a method for manufacturing an optical element by bonding the optical element in which a photosensitive layer and the protective layer are formed on the concave surface of the base material layer, and the optical element in which the photosensitive layer and the protective layer are formed on the convex surface of the base material layer. FIG. 10B illustrates a method for manufacturing an optical element by bonding the optical element in which a photosensitive layer and the protective layer are formed on the concave surface, and the optical element in which the photosensitive layer and the protective layer are formed on the concave surface. FIG. 10C illustrates a method for manufacturing an optical element by bonding the two optical elements illustrated in FIG. 10A after removing the two protective layers (the first protective layer 13 and the second protective layer 13-2) that face each other at the bonding surfaces. As a method for removing the above-described protective layer, a method similar to that in the example illustrated in FIG. 9C can also be used in the present embodiment.

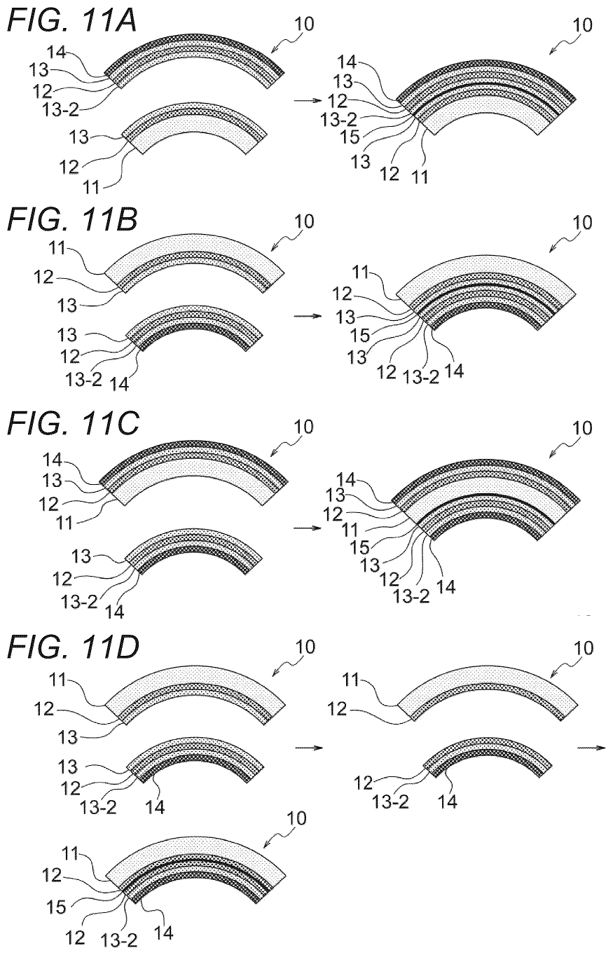

FIG. 11 illustrates an optical element manufactured by bonding an optical element selected from optical elements, each being obtained by removing the base material layer by peeling as illustrated in the fourth or fifth embodiment, and an optical element selected from optical elements as illustrated in the first to third embodiments or the sixth embodiment. FIG. 11A illustrates a method for manufacturing an optical element by bonding the optical element provided with an outer shell layer on the convex surface, and the optical element in which a photosensitive layer and a protective layer are formed on the convex surface of the base material layer. FIG. 11B illustrates a method for manufacturing an optical element by bonding the optical element in which a photosensitive layer and a protective layer are formed on the concave surface of the base material layer, and the optical element provided with an outer shell layer on the concave surface. FIG. 11C illustrates a method for manufacturing an optical element by bonding the optical element in which a photosensitive layer, a protective layer, and an outer shell layer are formed on the convex surface of the base material layer, and the optical element provided with an outer shell layer on the concave surface. FIG. 11D illustrates a method for manufacturing an optical element by bonding the two optical elements illustrated in FIG. 11B after removing the two protective layers that face each other at the bonding surfaces. As a method for removing the above-described protective layer, a method similar to that in the example illustrated in FIG. 9C can also be used in the present embodiment.

In the present embodiment, although the example of the optical element manufactured by bonding the two optical elements each provided with the photosensitive layer in which interference fringes have been recorded has been illustrated with reference to FIGS. 9 to 11, the present embodiment is not limited to the combinations illustrated in FIGS. 9 to 11, and, for example, any optical element may be manufactured by bonding two optical elements selected from among the optical elements according to the embodiments described in the present specification.

### 10 Tenth Embodiment

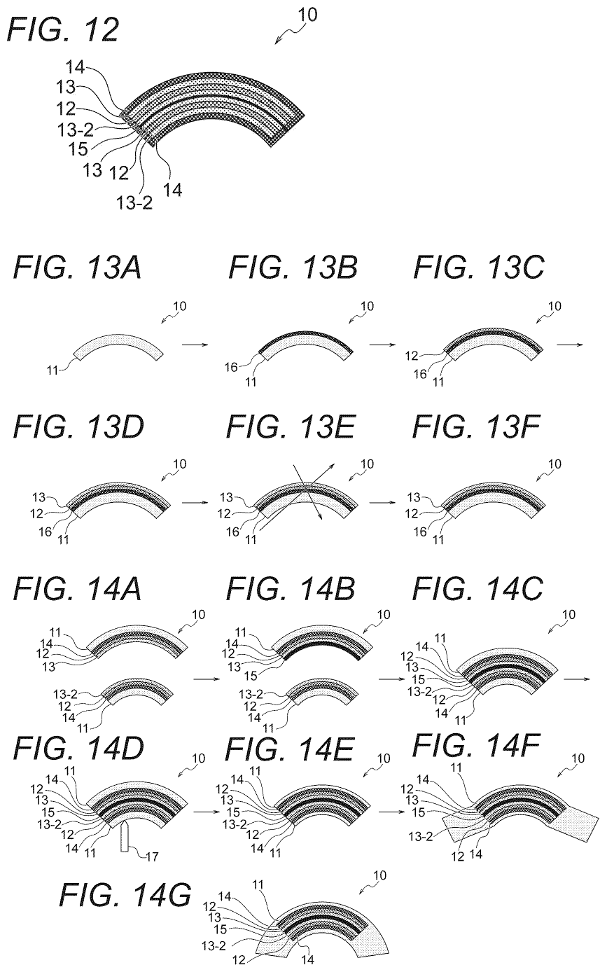

FIG. 12 illustrates an example of an optical element according to the ninth embodiment including two optical elements with an adhesive layer provided on adhesive surfaces of the two optical elements. The optical element of the present embodiment can be suitably produced by a method similar to the method for manufacturing an optical element used in the ninth embodiment except that the adhesive layer is provided on the adhesive surface of the two optical elements, and the material and configuration that can be used for the optical element according to the ninth embodiment can also be suitably used in the present embodiment.

Note that, in the optical element illustrated in FIG. 12, an example of the optical element including the outer shell layer has been illustrated from the viewpoint of enhancing the safety of the product including the optical element according to the present technology, but the present technology is not limited to the form of the optical element including the outer shell layer.

### Contact Lens

### 11 Eleventh Embodiment

FIGS. 13 and 14 illustrate an example of a method for manufacturing a contact lens including an optical element according to the present technology. FIG. 13 illustrates an example of a film formation process, and FIG. 14 illustrates an example of a lamination process.

In the method for manufacturing a contact lens according to the present embodiment, as illustrated in FIG. 13B, an inorganic material layer 16 is formed on a base material layer 11 including a contact lens material illustrated in FIG. 13A. Here, as the material for the above-described contact lens, known materials such as silicone methacrylate (SiMA), fluorinated methacrylate (FMA), poly(2-hydroxyethyl methacrylate) (P-HEMA), and silicone hydrogel (TRIS, SiGMA, and the like), which are used as base materials for contact lenses, can be suitably used. Furthermore, as a material for forming the inorganic material layer 16, an inorganic material such as SiO₂, TiO₂, Al₂O₃, SiNx used for an outer shell layer of a known contact lens or the like can be suitably used. The method for forming the inorganic material layer 16 can be suitably formed by the formation method and the like mentioned as the method for forming the outer shell layer described above.

Thereafter, as illustrated in FIG. 13C, a photosensitive layer 12 is formed on the inorganic material layer 16 using a photosensitive layer-forming solution, and as illustrated in FIG. 13D, a protective layer 13 is formed using a protective layer-forming solution.

Note that, although FIG. 13 illustrates an example in which the photosensitive layer 12 and the protective layer 13 are formed on the inorganic material layer 16, the inorganic material layer 16 may be formed after the photosensitive layer 12 and the protective layer 13 are formed on the base material layer 11.

FIG. 13E illustrates a process of producing a hologram by interference exposure, and FIG. 13F illustrates an optical element as a hologram in which interference fringes are recorded. Note that, in FIG. 13, although the example of manufacturing an optical element that controls light beams by reflective diffraction of reflected light incident on the optical element is illustrated, the optical element may be configured such that light beams are controlled by transmissive diffraction of transmitted light incident by emitting both the object light and the reference light to the optical element from the same direction for irradiation with the interference light in the interference exposing step. The conditions for interference exposure for recording interference fringes in the photosensitive layer, which can be used in the present embodiment, can also be suitably applied in the present embodiment as the interference exposure conditions described in the first embodiment and the like.

In the present embodiment, by the above-described film formation process, for example, it is preferable to form two different types of optical elements as a deflection optical element in which interference fringes as a hologram for deflection are recorded on the photosensitive layer and a lens optical element in which interference fringes as holograms for lenses are recorded on the photosensitive layer.

In the present embodiment, two types of optical elements obtained by the above-described film formation process are bonded as illustrated in FIG. 14A. For efficient bonding, as illustrated in FIG. 14B, an adhesive layer 15 may be provided on an adhesive surface of one optical element. FIG. 14C illustrates the optical element after bonding.

The bonded optical element is subjected to thickness adjustment of the base material layer 11 and surface processing of the optical element by polishing and/or cutting, using a cutting member, as illustrated in FIG. 14D. As the cutting member, a known cutting member capable of cutting the material for forming the base material layer 11 can be used, and known cutting means can be employed. Also in the polishing, a known polishing means can be suitably used. FIG. 14E illustrates an optical element in which the base material layer 11 is adjusted to a target thickness by cutting or the like using a cutting member. FIG. 14F illustrates a soft contact lens in which the shape is completed by immersing the optical element in physiological saline or the like to hydrate the optical element in a base material layer. FIG. 14G illustrates a modification of FIG. 14F. The contact lens illustrated in FIG. 14F is an example of a shape in which the curvature radius at the peripheral portion and the curvature radius near the center are different, whereas the contact lens illustrated in FIG. 14G is an example of a shape having the same curvature radius over the entire surface. A contact lens having the above-described shape can also be manufactured by the similar method as the optical element illustrated in FIG. 14E. Furthermore, the present technology can suitably adopt known contact lens shapes other than the shapes illustrated in FIGS. 14F and 14G.

### 12 Twelfth Embodiment

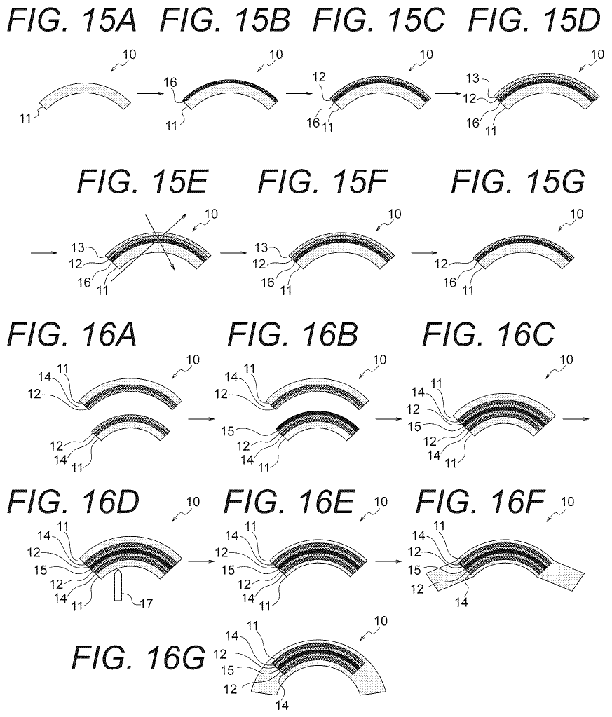

FIGS. 15 and 16 illustrate a modification of the method for manufacturing a contact lens including the optical element according to the present technology. FIG. 15 illustrates an example of a film formation process, and FIG. 16 illustrates an example of a lamination process.

In the present embodiment, in the film formation process of the eleventh embodiment, the protective layer 13 is removed using a solvent (for example, the solvent including one or more compounds selected from water, a water-soluble solvent, and a non-polar solvent) that dissolves the protective layer while retaining the photosensitive layer of the optical element as a hologram in which interference fringes have been recorded. Other than this, the optical element of the present embodiment can be suitably produced by a method similar to the method for manufacturing an optical element used in the eleventh embodiment, and materials and configurations that can be used for the optical element according to the eleventh embodiment can be suitably used in the present embodiment. Here, even though the protective layer 13 is removed, a small amount of a residue of the protective layer 13 may remain.

The protective polymer such as PVA contained in the protective layer may absorb water and swell or dissolve when the contact lens is worn by a user. Therefore, in the present embodiment, it is possible not only to reduce the number of layers constituting the optical element, but also to avoid swelling or dissolution of the contact lens by removing the protective layer 13 of the optical element as a hologram in which interference fringes have been recorded.

As a method for removing the protective layer 13, for example, the protective layer can be preferably removed by dissolving it with a solvent that can be used as a protective layer solvent, such as a non-polar solvent or a water-soluble solvent.

### 13 Thirteenth Embodiment

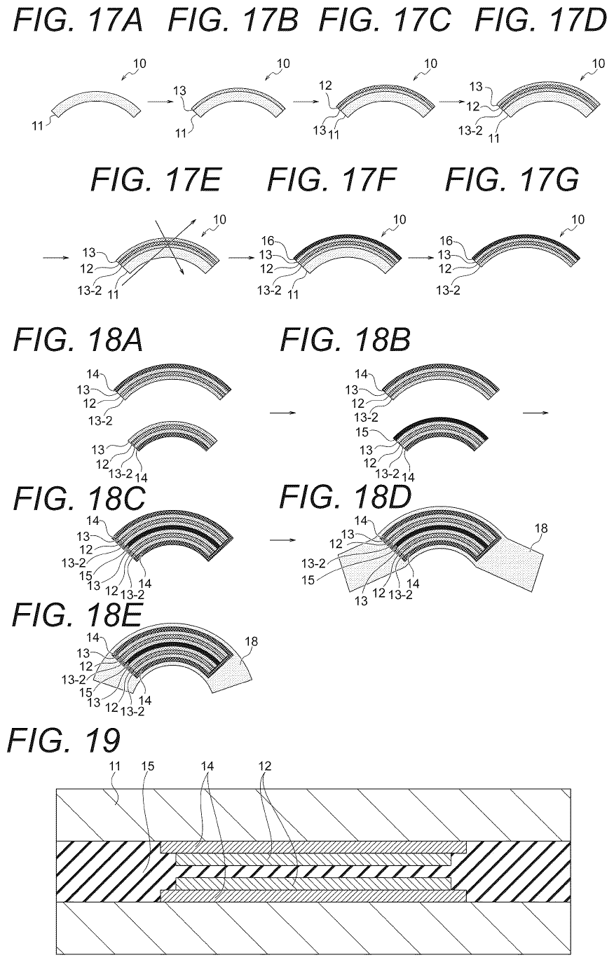

FIGS. 17 and 18 illustrate modifications of the method for manufacturing a contact lens provided with the optical element according to the present technology, and illustrate examples in which the number of layers constituting the optical element is reduced by removing the base material layer through peeling. FIG. 17 illustrates an example of a film formation process, and FIG. 18 illustrates an example of a lamination process. Note that, in the present embodiment as well, materials and configurations that can be used for the optical element according to the eleventh embodiment can be suitably used.

In the present embodiment, the second protective layer 13-2 is formed on the base material layer 11 illustrated in FIG. 17A by using a protective layer-forming solution, as illustrated in FIG. 17B. Subsequently, as illustrated in FIG. 17C, the photosensitive layer 12 is formed by using a photosensitive layer-forming solution, and as illustrated in FIG. 17D, the first protective layer 13 is formed by using a protective layer-forming solution.

FIG. 17E illustrates a process of producing a hologram by interference exposure. Subsequently, as illustrated in FIG. 17F, the outer shell layer 14 is formed on the convex surface of the optical element as a hologram in which interference fringes have been recorded. Note that, the hologram may also be manufactured by the exposure illustrated in FIG. 17E after the outer shell layer illustrated in FIG. 17F is first formed. Here, FIG. 17F illustrates the optical element in which the outer shell layer 14 is formed on the convex surface; however, for bonding of the optical elements as described later, although not illustrated, another optical element is prepared by sequentially forming a second protective layer on the concave surface, then forming a photosensitive layer, forming a first protective layer, performing exposure, and subsequently forming an outer shell layer on the surface. Thereafter, as illustrated in FIG. 17G, the base material layer 11 is separated and removed by peeling.

The two types of the optical elements obtained through the above-described film formation process are bonded together and used to manufacture the bonded optical element by the steps illustrated in FIGS. 18A and 18B. For this process, a method similar to the method for manufacturing the optical element used in the eleventh embodiment can be used. Thereafter, as illustrated in FIG. 18C, the outer shell layer is formed to cover the side surface portion of the optical element after adhesion. FIG. 18D illustrates a soft contact lens completed by forming a film of the contact layer 18 covering the surface of the optical element with a contact lens material by a known forming method, and then immersing the optical element in water to wet a water-containing layer 18. Examples of the known forming method include a coating method, or a molding method using a mold such as a mold method. As the material for forming the water-containing layer, a known material used as the material of the base material of the contact lens can be suitably used.

FIG. 19 illustrates an image of a cross-sectional structure of an example of a contact lens including an optical element according to the present technology. Note that, although the shape of the contact lens is not a flat surface, in FIG. 19, the cross-sectional structure will be schematically described using a plan view. The contact lens can be suitably produced by the method for manufacturing a contact lens described in the eleventh to thirteenth embodiments.

As illustrated in FIG. 19, since the two photosensitive layers 12 are covered with the adhesive layer 15, the two photosensitive layers 12 are not exposed to the outside. By using a material whose biocompatibility has been confirmed as a material for forming the adhesive layer 15, the safety of the contact lens can be secured. Furthermore, by increasing the distance from the end portion of the photosensitive layer 12 to the outer edge of the optical element, it is possible to inhibit leakage of the material for forming the photosensitive layer 13 from the contact lens.

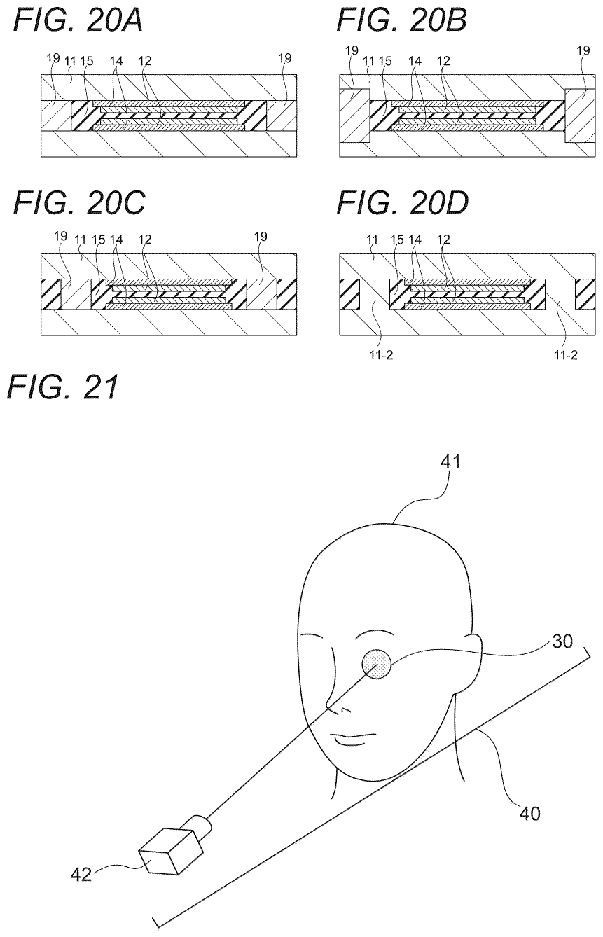

FIG. 20 illustrates an image of a cross-sectional structure of a modification of a contact lens including an optical element according to the present technology. Each of the contact lenses illustrated in FIG. 20 is the same as the contact lens illustrated in FIG. 19, except that it is provided with blocking structures for inhibiting leakage of the material for forming the photosensitive layer 12 from the side surfaces of the contact lens to the outside.

FIG. 20A includes sealing structures 19 as the above-described blocking structure. FIG. 20B illustrates a configuration in which the sealing surfaces (the surface facing the photosensitive layer 12) of the sealing structures 19 provided in FIG. 20A are enlarged. These contact lenses can be preferably manufactured by sealing, with sealing layers 19, the side surfaces of the contact lenses manufactured by the method for manufacturing a contact lens described in the above-described eleventh to thirteenth embodiments. Here, as the material for the sealing layer, for example, an adhesive containing an inorganic material (particles) is used. By containing a large amount of the inorganic material (particles), a leakage gap is narrowed to obtain sealability. The adhesive preferably has biocompatibility.

FIG. 20C illustrates a mode in which the sealing structures 19 are provided inward from the outer edge formed by the adhesive layer 15. The mode of FIG. 20C can be suitably manufactured, for example, by forming, before bonding the two optical elements, the sealing structures 19, each having a shape wider than the outer edge of the photosensitive layer 12 and narrower than the outer edge of the base material layer 11, on one base material layer 11, and then bonding the two optical elements. FIG. 20D illustrates an example in which projections 11-2 are provided on one optical element before bonding instead of the sealing structures 19 in FIG. 20C. In this embodiment, the projections 11-2 inhibit leakage of the material for forming the photosensitive layer 12 to the outside.

Here, although the blocking structures illustrated in FIGS. 20A to 20D are illustrated, the blocking structures applicable to the present technology are not limited to these, and known structures that inhibit leakage of internal materials to the outside can also be applied. Moreover, the blocking structures illustrated in FIG. 20 may also be used in combination of two or more types, such as a combination of the sealing structures, for example, illustrated in FIG. 20B and the sealing structures illustrated in FIG. 20C.

### 14 Fourteenth Embodiment

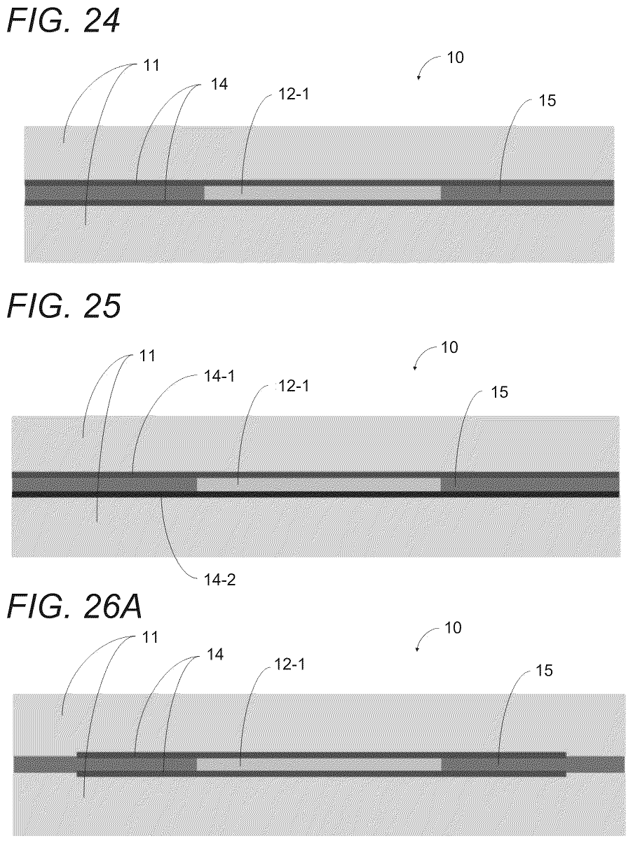

FIG. 24 illustrates an image of a cross-sectional structure of an optical element including an outer shell layer having gas permeability lower than that of a base material layer between a functional layer and the base material layer for the purpose of suitably sealing components in the base material layer. Although the shape of the optical element according to the present embodiment is illustrated as a planar shape in FIG. 24 and the like for convenience, depending on the intended application, such as contact lenses, any shape other than the planar shape illustrated in the present specification, such as a substantially curved surface shape can be adopted.

The optical element 10 of the present embodiment, as illustrated in FIG. 24, is an optical element including one or more functional layers 12-1 containing a low molecular weight compound within a base material layer 11. Since the outer shell layer 14 having lower gas permeability than the base material layer 11 is provided between the functional layer 12-1 and the base material layer 11, it is possible to suppress oozing out of the low molecular weight compound from the optical element 10 due to elution or the like even in a case where the functional layer 12-1 contains a low molecular weight compound. Therefore, even in a case where the low molecular weight compound contains a material whose biocompatibility has not been confirmed by a confirmation test of an influence on a living body or the like, the safety of the optical element 10 can be suitably improved.

Furthermore, in the embodiment illustrated in FIG. 24, an optical element having a configuration in which the base material layer includes two base material layers 11, and the outer shell layer 14 is provided on each of two surfaces of the functional layer 12-1 facing the two base material layers 11 is illustrated, but the embodiment is not limited to the embodiment illustrated in the example of FIG. 24 as long as components in the base material layer can be suitably sealed by the outer shell layer.

Moreover, in the embodiment illustrated in FIG. 24, the adhesive layer 15 is formed in a region where the outer shell layer 14 is not provided between the surface of the functional layer 12-1 and the surface of the optical element 10. As in the optical element illustrated in this example, it has been confirmed that even in the region of the surface of the functional layer 12-1 where the outer shell layer 14 is not provided, oozing out of the low molecular weight compound in the functional layer can be suppressed from the optical element due to elution or the like, by filling a material for forming the adhesive layer from the peripheral portion of the functional layer 12-1, where the outer shell layer 14 is not provided, toward the outer edge of the surface of the optical element 10, thereby forming an adhesive layer 15.

In the above-described case, the distance from the functional layer 12-1 sealed by the adhesive layer 15 to the surface of the optical element 10 is influenced by factors such as the gas permeability of the compound or composition forming the adhesive layer and the position at which the functional layer 12-1 is disposed within the optical element 10, but it can be designed, for example, within a range of 1.0 μm or more, 100 μm or more, or 1.0 mm or more.

The materials that can constitute each layer of the optical element according to the present embodiment may be suitably selected from among any of the materials described in the present specification as materials that can constitute each layer, depending on the purpose of the optical element or the like. Furthermore, the optical element according to the present embodiment can be suitably manufactured by any manufacturing method capable of manufacturing the optical element.

Next, a modification of the present embodiment will be described with reference to FIGS. 25 to 34. The optical element according to the present embodiment may adopt the configurations of the following modifications and the like, depending on the intended purpose of use and the like. Furthermore, these forms can also be used in combination. Note that, also in these modifications, depending on the purpose of the optical element or the like, any of the materials described in the present specification as materials that can constitute each layer may be suitably used. Furthermore, the optical elements according to these modifications can also be suitably manufactured by any manufacturing method capable of producing optical elements.

The optical element 10 illustrated in FIG. 25 is configured similarly to the optical element illustrated in FIG. 24, except that two outer shell layers 14-1 and 14-2 are provided so as to sandwich the functional layer 12-1, and the outer shell layers 14-1 and 14-2 have mutually different gas permeabilities. In the optical element 10 illustrated in FIG. 25, the outer shell layers 14-1 and 14-2 have mutually different gas permeabilities by differing in any requirement, such as the material for forming the outer shell layer, the thickness of the outer shell layer, or the configuration thereof (for example, a laminated structure).

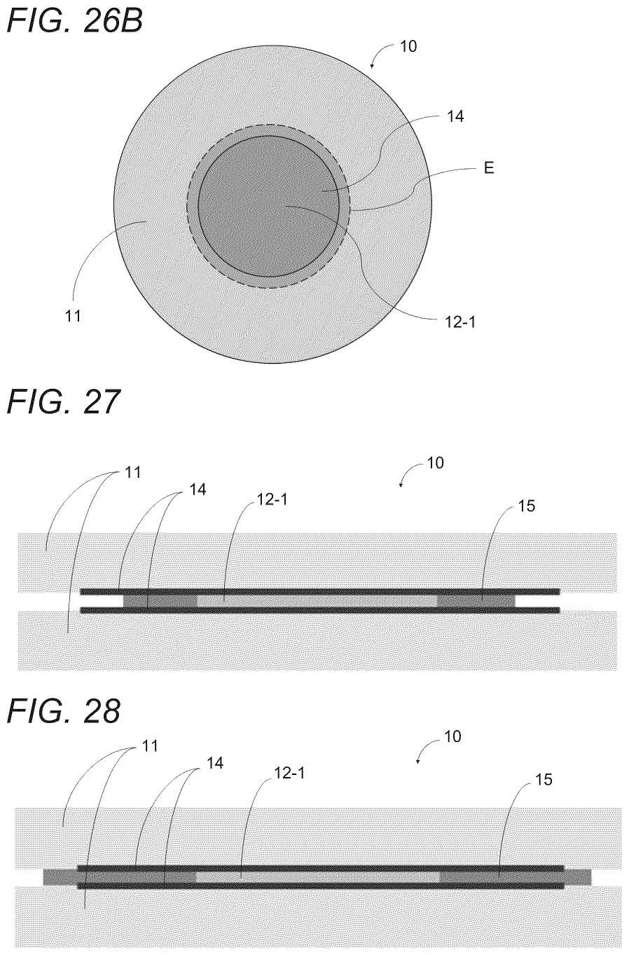

The optical element 10 illustrated in FIG. 26A is configured similarly to the optical element illustrated in FIG. 24, except that it has a region on the surface of the base material layer opposite to the functional layer, where the outer shell layer is not formed. In the optical element 10 illustrated in FIG. 26A, in the region where the outer shell layer is not formed, higher gas permeability can be ensured compared to the region where the outer shell layer 14 is formed. Accordingly, in the present embodiment, it is possible to achieve a balance between suppressing oozing out of the components of the functional layer to the outside and ensuring gas permeability, such as oxygen, as for the use of the optical element, in accordance with the intended purpose of the optical element.

FIG. 26B illustrates a top view image of an example in a case where the optical element 10 illustrated in FIG. 26A is used as a contact lens. As illustrated in FIG. 26B, the functional layer 12-1 is disposed near a position E corresponding to the pupil when the contact lens is worn, and the outer shell layer 14 is provided in the vicinity of the functional layer 12-1. It can be confirmed that, at the peripheral portion thereof, there is a region where the outer shell layer is not formed. Accordingly, in the contact lens, it is possible to suitably suppress the seepage of components of the functional layer 12-1 provided near the position corresponding to the pupil to the outside, and to ensure favorable permeability of gases such as oxygen in the region where the outer shell layer 14 is not formed. In the figure illustrated in FIG. 26B, an example is illustrated in which the range of the functional layer 12-1 is larger than the pupil; however, the present technology is not limited thereto. That is, the range of the functional layer 12-1 is not limited to the size of the pupil and may be equal to, smaller than, or larger than the pupil.

FIGS. 27 and 28 are modifications of the optical element illustrated in FIGS. 26A and 26B. In each case, the adhesive layer 15 is in a reduced form, by using a smaller amount of the material for forming the adhesive layer that is filled from the peripheral portion of the functional layer 12-1, where the outer shell layer 14 is not provided, toward the outer edge of the surface of the optical element 10, as Compared with the optical elements illustrated in FIGS. 26A and 26B. FIG. 27 illustrates a configuration in which the outer edge of the adhesive layer 15 is smaller than the outer edge of the outer shell layer 14, whereas FIG. 28 illustrates a configuration in which the outer edge of the adhesive layer 15 is larger than the outer edge of the outer shell layer 14.

FIG. 29 also illustrates a modification of the optical elements illustrated in FIGS. 26A and 26B, and is an example in which a functional layer 12-3 is further provided at the periphery of the functional layer 12-1. <29A> illustrates a cross-sectional shape of the optical element, and <29B> illustrates a top view image in the case where the optical element 10 is used as a contact lens. As illustrated in this figure, in the optical element 10 illustrated in FIG. 29, it can be confirmed that the functional layer 12-3 is disposed at the periphery of the functional layer 12-1, which is arranged near the center of the position E corresponding to the pupil.

Furthermore, in the example of the optical element illustrated in FIG. 29, it can be confirmed from <29A> that the single continuous outer shell layer 14 is provided between both main surfaces of the functional layers 12-1 and 12-3 and the base material layer 11, and that a region where the outer shell layer is not formed is provided at the peripheral portion of the outer shell layer 14.

For example, FIG. 30 is a modification of the optical element illustrated in FIG. 29. <30A> illustrates a cross-sectional shape of the optical element, and <30B> illustrates a top view image in the case where the optical element 10 is used as a contact lens. In the optical element 10 illustrated in this example, independent outer shell layers 14-3 and 14-4 are provided for the functional layers 12-1 and 12-3, respectively. Accordingly, in accordance with the arrangement of the functional layers, it is possible to readily adjust the balance between suppressing oozing out of the components of the functional layers to the outside and ensuring gas permeability, such as oxygen, as an optical element. For other configurations, an optical element similar to that illustrated in FIG. 29 can be suitably used.

Note that, in the example of the optical element illustrated in FIG. 30, although the example is illustrated in which the functional layer 12-1 is disposed near the position E corresponding to the pupil, and the functional layer 12-3 is disposed at the periphery of the functional layer 12-1; however, also in the example illustrated in FIG. 30, similar to that in the example of the optical element illustrated in FIG. 29 described above, it is also possible to adopt a design in which the functional layer 12-1 is disposed in the vicinity of the position E corresponding to the pupil, and the functional layer 12-3 is disposed at the periphery thereof. In contrast, the optical element illustrated in FIG. 29 may also be designed such that the functional layer 12-1 is disposed near the position E corresponding to the pupil, and the functional layer 12-3 is disposed at the periphery of the functional layer 12-1, similar to that in the case of the optical element illustrated in FIG. 30.

Note that, in a case where a design is adopted in which the functional layer 12-1 is disposed near the position E corresponding to the pupil and the functional layer 12-3 is disposed at the periphery of the functional layer 12-1, as in the example of the optical element illustrated in FIG. 30, the wearing comfort of the contact lens can be improved, for example, by disposing the above-described photosensitive layer or the like near the pupil and disposing components with low transparency, such as a semiconductor layer or electrical wiring, in the peripheral portion.

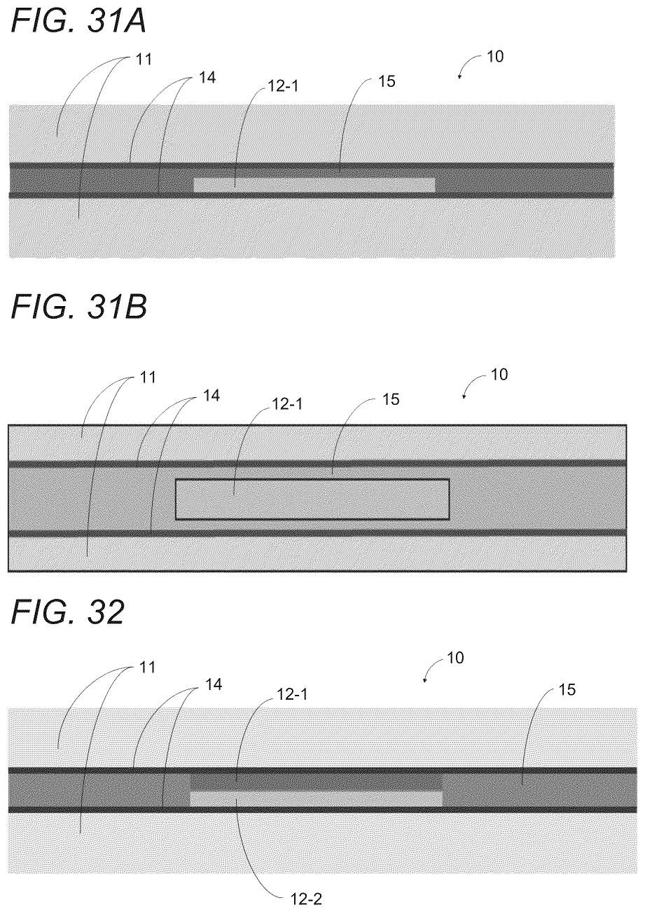

The optical element 10 illustrated in FIG. 31A is configured such that, on one main surface of the functional layer 12-1, the functional layer 12-1 and the outer shell layer 14 are directly bonded, whereas on the other main surface of the functional layer 12-1, the functional layer 12-1 and the outer shell layer 14 are not directly bonded, and an adhesive layer 15 is provided therebetween. In this configuration, the bonding strength between the functional layer and the outer shell layer can be enhanced by providing the adhesive layer 15 between the functional layer 12-1 and the outer shell layer 14. Other configurations are similar to the configuration of the optical element illustrated in FIG. 24. The optical element illustrated in FIG. 31B is a modification of the optical element illustrated in FIG. 31A, and is configured such that the functional layer 12-1 is sandwiched by the adhesive layers 15. Also in the optical element illustrated in FIG. 31B, similarly to the optical element illustrated in FIG. 31A, by providing the adhesive layer 15 between the functional layer 12-1 and the outer shell layer 14, the bonding strength between the functional layer and the outer shell layer can be increased.

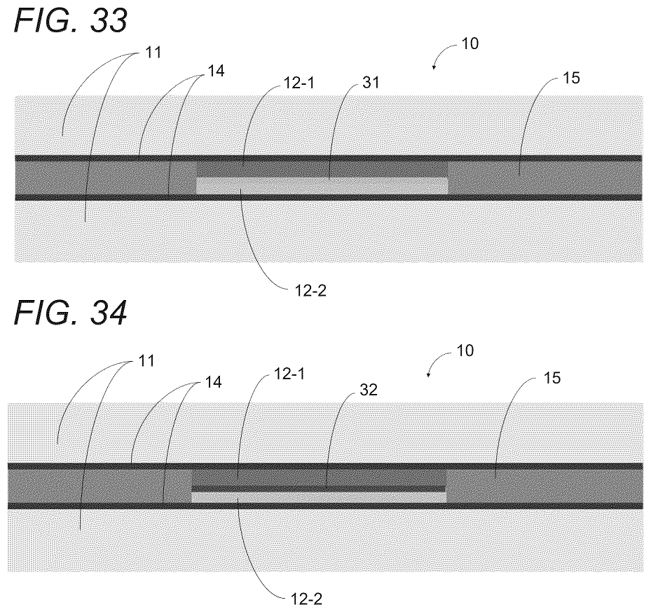

The optical element 10 illustrated in FIG. 32 is configured similarly to the optical element illustrated in FIG. 24 except that the optical element includes two functional layers 12-1 and 12-2. FIGS. 33 and 34 illustrate a mode in which two functional layers (functional layer 12-1 and functional layer 12-2) are not directly bonded to each other but bonded to each other with an intermediate layer interposed therebetween in the optical element 10 illustrated in FIG. 32.

The optical element 10 illustrated in FIG. 33 includes a barrier layer 31 as an intermediate layer. In the configuration illustrated in FIG. 33, a barrier layer 31 is provided between the functional layers 12-1 and 12-2. Therefore, it is possible to suppress compounds contained in the respective functional layers from reacting at the interface between the functional layers. The barrier layer that can be used in the present embodiment is not particularly limited, and any layer that can exhibit the above effect can be suitably used.

The optical element 10 illustrated in FIG. 34 includes an insulating layer 32 as an intermediate layer. In the embodiment illustrated in FIG. 34, by providing the insulating layer 32 between the functional layer 12-1 and the functional layer 12-2, an electrical insulation effect and an electromagnetic wave shielding effect between the functional layers are obtained. The insulating layer that can be used in the present embodiment is not particularly limited, and any layer that can exhibit the above effect can be suitably used.

In any of the optical elements illustrated in the present embodiment, by providing an outer shell layer having lower gas permeability than that of the base material layer between the functional layer and the base material layer, it is possible to suitably suppress oozing out of the low molecular weight compound to the outside of the optical element due to elution or the like even in a case where the functional layer contains such compounds.

### 15 Fifteenth Embodiment

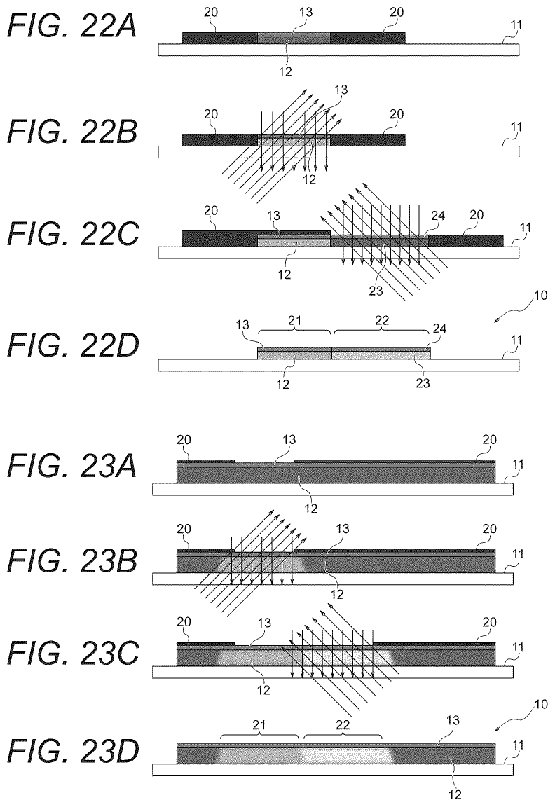

FIG. 21 illustrates an example of a display system including a contact lens as an example of the optical device and a projection system as an example of an optical device including an optical element according to the present technology. The light emitted from a projection system (image projection device) 42 enters the contact lens 30 provided with the optical element according to the present technology. The contact lens 30 diffracts incident light by the optical element according to the present technology to control light beams, and illustrates an image or the like to the user 41. Note that the example illustrated in FIG. 21 is a display system as an example of a system including the optical device according to the present technology. However, the system according to the present technology is not limited to the embodiment illustrated in this example, and a system can be constructed by combining an optical device provided with the optical element according to the present technology with any external device, depending on the purpose of the system.

### 16 Sixteenth Embodiment

FIG. 22 illustrates a modification of the method for manufacturing the optical element according to the present technology. The present embodiment relates to an optical element as a hologram including a photosensitive layer that records different interference fringes in at least two regions of an optical element surface.

FIG. 23 illustrates a method for manufacturing an optical element according to the related art, the optical element including a photosensitive layer that records different interference fringes in at least two regions of an optical element surface. In the related art, as illustrated in FIG. 23A, the optical element 10 manufactured by a method such as bonding of a film including the photosensitive layer 12 and the protective layer 13 on the base material layer 11 is shielded from light in a region other than a region to be exposed by a light-shielding mask 20.

FIG. 23B illustrates a process of producing a hologram by interference exposure of the first formation region 21, and FIG. 23C illustrates a process of removing a part of the light-shielding mask 20 to produce a hologram by interference exposure of the second formation region 22.

At the time of the interference exposure, as illustrated in FIGS. 23B and 23C, the light to be recorded often has an angle and is not perpendicularly incident on the opened region of the light-shielding mask, and a photochemical reaction may occur in the photosensitive layer outside the target region. Moreover, a photochemical reaction may occur in the photosensitive layer outside the target region by diffraction of light generated at the end portion of the light-shielding mask. As a result, the interference fringes recorded in the first formation region 21 and the second formation region 22 are disturbed as in the optical element illustrated in FIG. 23D, and thus, there is a possibility that the diffracted light cannot be accurately reproduced.

In contrast, in the method for manufacturing the optical element according to the present embodiment, as illustrated in FIG. 22A relating to the first forming step, the first photosensitive layer 12 and the first protective layer 13 are formed in a first formation region 21, which is a part of one surface of the base material layer 11. Since the photosensitive layer 12 and the protective layer 13 are formed only in the first formation region 21, which is the initial exposure target of the base material layer 11, even though light is incident from a direction other than perpendicular to the open region of the light-shielding mask 20 during the interference exposure illustrated in FIG. 22B, a photochemical reaction does not occur in regions other than a first exposure region 21.

Thereafter, as illustrated in FIG. 22C related to the second forming step, the second photosensitive layer 23 and the second protective layer 24 are formed in the second formation region 22 disposed in the vicinity of the first formation region 21 on one surface of the base material layer 11. Thereafter, as illustrated in FIG. 22C, a photochemical reaction is caused only in the second formation region 22 by the second exposing step of exposing the second formation region 22. As a result, as illustrated in FIG. 22D, different interference fringes can be suitably recorded in at least two regions of the optical element surface without disturbing the interference fringes recorded in the first formation region 21 and the second formation region 22. Note that the conditions for interference exposure for recording interference fringes in the photosensitive layer, which can be used in the present embodiment, may also suitably be the same as the interference exposure conditions described in the first embodiment and the like.

In the modification of the method of manufacturing the optical element according to the present technology illustrated in FIG. 22, the example of the method of manufacturing the optical element using the light-shielding mask 20 has been described; however, since the interference fringe is recorded after the photosensitive layer and the protective layer are formed for each formation region, and then the interference fringe is recorded after the photosensitive layer and the protective layer are formed in the next formation region, in a case where the formation region can be limited by dividing each region, the light-shielding mask 20 may be used that does not shield light but transmits light.

Here, in the present embodiment, the first formation region 21 and the second formation region 22 may be disposed adjacent to each other.

Furthermore, in FIG. 22, the method of manufacturing the optical element according to the present embodiment for the base material layer having a planar shape is illustrated, but the present embodiment is not limited to the planar shape. That is, in the present technology, for example, since the photosensitive layer and the protective layer can be formed by coating, it is possible to manufacture an optical element as a hologram including a photosensitive layer that records different interference fringes in at least two regions of the surface of the base material layer with respect to any shape.

Note that the present technology can have the following configurations.

(1) An optical element including:
a base material layer; and at least a photosensitive layer and a protective layer adjacent to the photosensitive layer on one surface of the base material layer,
in which the photosensitive layer contains a derivative of a photosensitizing substance and a polymer of a photosensitizing polymerizable monomer,
the protective layer contains a protective polymer soluble in a protective layer solvent and a compound related to the protective layer solvent, and
the protective layer solvent does not dissolve the photosensitive layer.

(2) An optical element including:
a photosensitive layer; and a protective layer adjacent to at least one surface of the photosensitive layer,
in which the photosensitive layer contains a photosensitizing substance or a derivative of the photosensitizing substance and a polymer of a photosensitizing polymerizable monomer,
the protective layer contains a protective polymer soluble in a protective layer solvent and a compound related to the protective layer solvent, and
the protective layer solvent does not dissolve the photosensitive layer.

(3) The optical element according to (1) or (2), in which the protective layer contains the compound related to the protective layer solvent in an amount of 0.01% by mass or more and 99% by mass or less.

(4) The optical element according to any one of (1) to (3), in which the compound related to the protective layer solvent includes one or more compounds selected from water, a water-soluble solvent, and a non-polar solvent.

(5) An optical element including:
a base material layer; and at least a photosensitive layer and a protective layer adjacent to the photosensitive layer on one surface of the base material layer,
in which the photosensitive layer contains a derivative of a photosensitizing substance and a polymer of a photosensitizing polymerizable monomer,
the protective layer contains a protective polymer soluble in a protective layer solvent,
the protective layer solvent does not dissolve the photosensitive layer, and
the optical element does not have a planar shape.

(6) An optical element including:
a photosensitive layer; and a protective layer adjacent to at least one surface of the photosensitive layer,
in which the photosensitive layer contains a photosensitizing substance or a derivative of the photosensitizing substance and a polymer of a photosensitizing polymerizable monomer,
the protective layer contains a protective polymer soluble in a protective layer solvent,
the protective layer solvent does not dissolve the photosensitive layer, and
the optical element does not have a planar shape.

(7) The optical element according to (5) or (6), in which the optical element has a substantially curved surface shape other than the planar shape.

(8) The optical element according to (7), in which the substantially curved surface shape has a curvature radius of 740 mm or less.

(9) The optical element according to (7), in which the substantially curved surface shape has a curvature radius of 0 mm or less.

(10) The optical element according to any one of (1) to (7), in which the protective polymer includes one or more compounds selected from polyvinyl alcohol, polyethylene glycol (PEG), polyethylene oxide (PEO), polyacrylamide (PAM), a carboxymethyl cellulose (CMC) resol-type phenolic resin, a methylolated urea resin, a methylolated melamine resin, and polyethylene.

(11) The optical element according to any one of (1) to (10), in which a surface of the photosensitive layer opposite to the surface adjacent to the protective layer is further adjacent to a second protective layer.

(12) The optical element according to any one of (1) to (11), further including an outer shell layer that covers at least a part of a surface of the optical element.

(13) The optical element according to (12), in which the outer shell layer contains an inorganic material.

(14) The optical element according to (1) to (4) or (10) to (13), in which the optical element does not have a planar shape.

(15) The optical element according to (14), in which the optical element has a substantially curved surface shape other than the planar shape.

(16) The optical element according to (15), in which the substantially curved surface shape has a curvature radius of 740 mm or less.

(17) The optical element according to (15), in which the substantially curved surface shape has a curvature radius of 10 mm or less.

(18) The optical element according to any one of (1) to (17), in which a difference between a maximum value and a minimum value of a thickness of a surface of the optical element in a normal direction is 20 μm or less.

(19) The optical element according to any one of (1) to (18), in which a difference between a maximum value and a minimum value of a thickness of the photosensitive layer in a normal direction is 10 μm or less.

(20) The optical element according to any one of (1) to (19), in which the photosensitive layer records interference fringes.

(21) An optical element including:
a base material layer; and at least a photosensitive layer and a protective layer adjacent to the photosensitive layer on one surface of the base material layer,
in which the photosensitive layer contains a photosensitizing substance and a photosensitizing polymerizable monomer,
the protective layer contains a protective polymer soluble in a protective layer solvent and a compound related to the protective layer solvent, and
the protective layer solvent does not dissolve the photosensitive layer.

(22) A method for manufacturing an optical element including:
on one surface of a base material layer, forming a photosensitive layer with a photosensitive layer-forming solution prepared by dissolving at least a photosensitizing substance and a photosensitizing polymerizable monomer in a polar solvent, and
forming a protective layer adjacent to the photosensitive layer with a protective layer-forming solution, in which a protective polymer soluble in a protective layer solvent that does not dissolve at least the photosensitive layer is dissolved in the protective layer solvent.

(23) The method for manufacturing an optical element according to (22), in which the photosensitive layer is formed after a second protective layer is formed on the one surface of the base material layer.

(24) The method for manufacturing an optical element according to (22) or (23), in which the base material layer does not have a planar shape.

(25) The method for manufacturing an optical element according to any one of (22) to (24), further including:
a first forming step of forming a first of the photosensitive layers and forming a first of the protective layers in a first formation region that is a part of the one surface of the base material layer;
a first exposing step of exposing the first formation region;
a second forming step of forming a second of the photosensitive layers and forming a second of the protective layers in a second formation region disposed in a vicinity of the first formation region on the one surface of the base material layer; and
a second exposing step of exposing the second formation region.

(26) The method for manufacturing an optical element according to (25), in which the second formation region is adjacent to the first formation region.

(27) The method for manufacturing an optical element according to any one of (22) to (26), in which the formation is performed by any one of methods as follows: jetting, spraying, dipping, and spin coating.

(28) A solution set for manufacturing an optical element containing a photosensitive layer-forming solution prepared by dissolving at least a photosensitizing substance and a photosensitizing polymerizable monomer in a polar solvent, and
a protective layer-forming solution in which at least a protective polymer soluble in a protective layer solvent that does not dissolve the photosensitive layer is dissolved in the protective layer solvent.

(29) A material set of a protective layer-forming solution that forms a protective layer adjacent to a photosensitive layer of an optical element, the material set including:
a protective layer solvent that does not dissolve at least the photosensitive layer; and
a protective polymer soluble in the protective layer solvent,
in which the photosensitive layer is formed with a photosensitive layer-forming solution prepared by dissolving at least a photosensitizing substance and a photosensitizing polymerizable monomer in a polar solvent.

(30) An optical device including the optical element according to any one of (1) to (21).

(31) A system including the optical device according to (30) and an external device.

(32) A contact lens including the optical element according to any one of (1) to (21).

(33) A display system including the contact lens according to (32) and a projection system.

Moreover, note that the present technology can have the following configurations.

<1> An optical element including one or more functional layers containing a low molecular weight compound in an inside of a base material layer,
in which an outer shell layer having a lower gas permeability than that of the base material layer is provided between the functional layer and the base material layer.

<2> The optical element according to <1>, in which the base material layer includes two base material layers, and the two base material layers form the inside.

<3> the optical element according to <1> or <2>, in which the outer shell layer is provided on each of two surfaces of the functional layer facing the base material layer.

<4> The optical element according to <3>, in which the outer shell layer has a distinct gas permeability.

<5> The optical element according to any one of <1> to <4>, further including an adhesive layer, in which the functional layer is sealed by the adhesive layer.

<6> The optical element according to <5>, in which in a region where the outer shell layer is not provided between the surface of the functional layer and the surface of the optical element, the adhesive layer seals a space between the functional layer and the surface of the optical element over a range of, for example, 1.0 μm or more, 100 μm or more, or 1.0 mm or more.

<7> The optical element according to any one of <1> to <6>, in which the functional layer and the outer shell layer are directly bonded.

<8> The optical element according to any one of <1> to <6>, in which the functional layer and the outer shell layer are not directly bonded.

<9> The optical element according to any one of <1> to <8>, in which the outer shell layer is formed over the entire surface of a surface of the base material layer opposite to the functional layer.

<10> The optical element according to any one of <1> to <8>, in which a region where the outer shell layer is not formed is provided on the surface of the base material layer opposite to the functional layer.

<11> The optical element according to any one of <1> to <10>, including two or more functional layers.

<12> The optical element according to <11>, in which the two or more functional layers are not directly bonded to each other.

<13> The optical element according to <11>, in which the two or more functional layers are bonded to each other with an intermediate layer interposed therebetween.

<14> The optical element according to any one of <1> to <13>, in which the functional layer is a photosensitive layer. <15> The optical element according to any one of <1> to <14>, in which the outer shell layer includes an inorganic material.

<16> The optical element according to any one of <1> to <15>, in which the optical element does not have a planar shape.

<17> The optical element according to <16>, in which the optical element has a substantially curved surface shape other than the planar shape.

<18> The optical element according to <17>, in which the substantially curved surface shape has a curvature radius of 740 mm or less.

<19> The optical element according to <17>, in which the substantially curved surface shape has a curvature radius of 10 mm or less.

<20> The optical element according to any one of <1> to <19>, in which a difference between a maximum value and a minimum value of a thickness of a surface of the optical element in a normal direction is 20 μm or less.

<21> The optical element according to any one of <1> to <19>, in which a difference between a maximum value and a minimum value of a thickness of the photosensitive layer in a normal direction is 10 μm or less.

<22> An optical device including the optical element according to any one of <1> to <21>.

<23> A system including the optical device according to <22> and an external device.

<24> A contact lens including the optical element according to any one of <1> to <21>.

<25> A display system including the contact lens according to <24> and a projection system.

### Reference Signs List

10 Optical element
11 Base material layer
11-2 Projection
12 Photosensitive layer
12-1, 12-2, 12-3 Functional layer
13 Protective layer (first protective layer)
13-2 Protective layer (second protective layer)
14, 14-1, 14-2, 14-3, 14-4 Outer shell layer
15 Adhesive layer
16 Inorganic material layer
17 Cutting member
18 Contact layer
19 Sealing structure
20 Light-shielding mask
21 First formation region
22 Second formation region
23 Second photosensitive layer
24 Second protective layer
30 Optical device (contact lens)
31 Barrier layer
32 Insulating layer
40 Display system
41 User
42 Projection system (video projection device)
E Position corresponding to pupil

What is claimed is:

1. An optical element comprising:
a base material layer; and at least a photosensitive layer and a protective layer adjacent to the photosensitive layer on one surface of the base material layer,
wherein the photosensitive layer at least contains a derivative of a photosensitizing substance and a polymer of a photosensitizing polymerizable monomer,
the protective layer contains a protective polymer soluble in a protective layer solvent and a compound related to the protective layer solvent, and
the protective layer solvent does not dissolve the photosensitive layer.

2. An optical element comprising:
a photosensitive layer; and a protective layer adjacent to at least one surface of the photosensitive layer,
wherein the photosensitive layer contains a photosensitizing substance or a derivative of the photosensitizing substance and a polymer of a photosensitizing polymerizable monomer,
the protective layer contains a protective polymer soluble in a protective layer solvent and a compound related to the protective layer solvent, and
the protective layer solvent does not dissolve the photosensitive layer.

3. The optical element according to claim 1 or 2, wherein the protective layer contains the compound related to the protective layer solvent in an amount of 0.01% by mass or more and 99% by mass or less.

4. The optical element according to claim 1 or 2, wherein the compound related to the protective layer solvent includes one or more compounds selected from water, a water-soluble solvent, and a non-polar solvent.

5. The optical element according to claim 1 or 2, wherein the protective polymer includes one or more compounds selected from polyvinyl alcohol, polyethylene glycol (PEG), polyethylene oxide (PEO), polyacrylamide (PAM), a carboxymethyl cellulose (CMC) resol-type phenolic resin, a methylolated urea resin, a methylolated melamine resin, and polyethylene.

6. The optical element according to claim 1 or 2, wherein a surface of the photosensitive layer opposite to the surface adjacent to the protective layer is further adjacent to a second protective layer.

7. The optical element according to claim 1 or 2, further comprising an outer shell layer that covers at least a part of a surface of the optical element.

8. The optical element according to claim 7, wherein the outer shell layer contains an inorganic material.

9. The optical element according to claim 1 or 2, wherein the optical element does not have a planar shape.

10. The optical element according to claim 9, wherein the optical element has a substantially curved surface shape other than the planar shape.

11. The optical element according to claim 10, wherein the substantially curved surface shape has a curvature radius of 740 mm or less.

12. The optical element according to claim 10, wherein the substantially curved surface shape has a curvature radius of 10 mm or less.

13. The optical element according to claim 1 or 2, wherein a difference between a maximum value and a minimum value of a thickness of the photosensitive layer in a normal direction is 10 μm or less.

14. The optical element according to claim 1 or 2, wherein the photosensitive layer records interference fringes.

15. An optical element comprising:
a base material layer; and at least a photosensitive layer and a protective layer adjacent to the photosensitive layer on one surface of the base material layer,
wherein the photosensitizing substance and a photosensitizing polymerizable monomer,
the protective layer contains a protective polymer soluble in a protective layer solvent and a compound related to the protective layer solvent, and
the protective layer solvent does not dissolve the photosensitive layer.

16. A method for manufacturing an optical element comprising:
on one surface of a base material layer, forming a photosensitive layer with a photosensitive layer-forming solution prepared by dissolving at least a photosensitizing substance and a photosensitizing polymerizable monomer in a polar solvent, and
forming a protective layer adjacent to the photosensitive layer with a protective layer-forming solution, in which a protective polymer soluble in a protective layer solvent that does not dissolve at least the photosensitive layer is dissolved in the protective layer solvent.

17. The method for manufacturing an optical element according to claim 16, wherein the photosensitive layer is formed after a second protective layer is formed on the one surface of the base material layer.

18. The method for manufacturing an optical element according to claim 16, wherein the base material layer does not have a planar shape.

19. The method for manufacturing an optical element according to claim 16, further comprising:
a first forming step of forming a first of the photosensitive layers and forming a first of the protective layers in a first formation region that is a part of the one surface of the base material layer;
a first exposing step of exposing the first formation region;
a second forming step of forming a second of the photosensitive layers and forming a second of the protective layers in a second formation region disposed in a vicinity of the first formation region on the one surface of the base material layer; and
a second exposing step of exposing the second formation

20. The method for manufacturing an optical element according to claim 19, wherein the second formation region is adjacent to the first formation region.

21. The method for manufacturing an optical element according to claim 16, wherein the formation is performed by any one of methods as follows: jetting, spraying, dipping, and spin coating.

22. A material set of a protective layer-forming solution that forms a protective layer adjacent to a photosensitive layer of an optical element, the material set comprising:
a protective layer solvent that does not dissolve at least the photosensitive layer; and
a protective polymer soluble in the protective layer solvent,
wherein the photosensitive layer is formed with a photosensitive layer-forming solution prepared by dissolving at least a photosensitizing substance and a photosensitizing polymerizable monomer in a polar solvent.

23. An optical device comprising the optical element according to claim 1 or 2.

24. A system comprising the optical device according to claim 23 and an external device.
